(19) United States
(12) Patent Application Publication
(10) Pub. No.: US 2026/0214089 A1
(43) Pub. Date: Jul. 23, 2026

(54) PERFORMING TRUST PROVISION OPERATIONS BASED ON DOMAIN NAME RELATED INFORMATION

(71) Applicant: Verisign, Inc., Reston, VA (US)

(72) Inventor: Swapneel Sheth, Fairfax, VA (US)

(73) Assignee: Verisign, Inc., Reston, VA (US)

(21) Appl. No.: 19/450,397

(22) Filed: Jan. 15, 2026

Related U.S. Application Data
(60) Provisional application No. 63/746,647, filed on Jan. 17, 2025.

(51) Int. Cl. H04L 9/40

(52) U.S. Cl. CPC H04L 63/0823

(57) ABSTRACT

Techniques for performing trust provision operation(s) in a digital environment based on domain name related information are described herein. For example, a trust provision operation may be configured to issue, distribute, determine a status for, and/or revoke a digital certificate associated with an electronic resource (e.g., a domain name such as a second-level domain name or a subdomain, a digital content file, and/or the like). In some cases, the trust provision operation(s) may be configured to enable a certificate status determination system to determine a status for a digital certificate based on domain name related information. In some cases, the trust provision operation(s) may be configured to enable a certificate authority (CA) system to determine whether to issue or reissue a digital certificate (e.g., a time-limited digital certificate) based on domain name related information.

### CROSS-REFERENCES TO RELATED APPLICATION(S)

This application claims the benefit of U.S. Provisional Patent Application No. 63/746,647, entitled “Performing Trust Provision Operations Based on Domain Name Related Information” and filed on Jan. 17, 2025, which is incorporated herein by reference in its entirety and for all purposes.

### BACKGROUND

In digital environments, secure communication between computer systems is important for protecting sensitive information and ensuring trust between communicating parties. One common method for establishing secure communication channels is through the use of digital certificates or assertions, such as X.509 certificates used in protocols like Transport Layer Security (TLS) and Secure Sockets Layer (SSL).

Digital certificates may be issued by trusted third parties, such as Certificate Authorities (CAs), and serve to bind a public key to an identity, such as a domain name. When a client device connects to a server over a secure channel, the server presents its digital certificate to the client device to authenticate the server's identity. The client device may determine a status for the certificate's authenticity based on the certificate's signature and the CA's public key and/or by determining whether the certificate is valid (e.g., has not expired and/or been revoked).

However, the current digital certificate and assertion solutions face several challenges. One significant challenge is the lack of sufficiently effective mechanisms for ensuring that digital certificates are only issued to authorized entities. Another significant challenge is the difficulty in managing the lifecycle of digital certificates and assertions relative to the underlying identity. Given these challenges, there is a need for improved solutions for issuing, managing, and/or determining a status for digital certificates and assertions.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 provides an example digital environment for performing one or more trust provision operations.

FIG. 2A provides an example process for issuing and determining a status for a digital certificate.

FIG. 2B provides an example process for issuing and determining a status for a digital certificate using stapled status responses.

FIG. 3 provides an operational example of establishing a secure communication channel between a web server and a client.

FIG. 4 provides an operational example of establishing a secure communication channel between a web server and a client in a networked system (e.g., an enterprise system).

FIG. 5 provides an operational example of authenticating and/or determining a status for a digital content file.

FIG. 6 provides a network architecture for digital certificate status determination in which a registry operates as a certificate status provider.

FIG. 7 provides a network architecture for digital certificate status determination in which a certificate authority (CA) operates as both a digital certificate issuer and a digital certificate status provider.

FIG. 8 provides a network architecture for digital certificate status determination in which both a registry and a CA operate as certificate status providers.

FIG. 9 provides a network architecture for digital certificate status determination in which a registry operates as a certificate status provider for a domain name that is not associated with the registry's top-level domain (TLD).

FIG. 10 provides a network architecture for digital certificate status determination for a subdomain.

FIG. 11 provides a network architecture for digital certificate status determination for a digital certificate associated with a digital content file.

FIG. 12 is a flowchart diagram of an example process for determining a certificate status response based on domain name related information.

FIG. 13 provides an operational example of determining a secure communication channel between a web server and a client using a time-limited digital certificate.

FIG. 14 is a flowchart diagram of an example process for issuing a time-limited digital certificate.

FIG. 15 is a flowchart diagram of an example process for performing certificate status determination operations based on domain name related information.

FIG. 16 is a flowchart diagram of an example process for digital certificate management based on domain name related information.

FIG. 17 depicts an example computing device for implementing the techniques described herein.

### DETAILED DESCRIPTION

This disclosure describes techniques for performing trust provision operation(s) in a digital environment based on domain name related information, such as domain name registration data. A trust provision operation may include one or more processes configured to establish, maintain, and/or verify one or more trust relationships in the digital environment. For example, a trust provision operation may be configured to issue, distribute, determine a status for, and/or revoke a digital certificate (e.g., a Secure Sockets Layer (SSL) certificate, a Transport Layer Security (TLS) certificate, and/or the like) that attests to the association between an entity, a public key, one or more attributes, and/or the like. The certificate may further be associated with an electronic resource (e.g., a domain name such as a second-level domain name or a subdomain, a digital content file, and/or the like). In some cases, the trust provision operation(s) may be configured to enable a certificate status determination system (e.g., an Online Certificate Status Protocol (OCSP) responder system) to determine the status of a digital certificate (e.g., a SSL certificate, a TLS certificate, and/or the like), including whether the digital certificate is invalid (e.g., revoked) or valid, based on domain name related information. In some cases, the trust provision operation(s) may be configured to enable a certificate authority (CA) system to determine whether to issue (e.g., generate) and/or reissue a digital certificate (e.g., a time-limited digital certificate, for example as further described below) based on domain name related information. A digital certificate associated with an electronic resource (e.g., a domain name, digital content file, and/or the like) may be associated with (e.g., may attest to an association between a cryptographic value such as a public key with and) an entity (e.g., with a signer that generates a digital signature for the electronic resource to indicate the signer's approval of the electronic resource and/or the signer's approval of the contents of the file) and/or an identifier (e.g., a domain name) of the entity. A digital certificate associated with an electronic resource (e.g., a domain name, digital content file, and/or the like) may attest to an association between cryptographic value such as a public key and an entity and/or an identifier of an entity that that performs one or more operations related to the electronic signature (e.g., with a signer that generates a digital signature for the electronic resource). The entity (e.g., a signer) may be identified by a legal name, common name, domain name, email address, username, account number, and/or the like, and/or by a cryptographic value such as a public key and/or a hash of a public key. In some cases, a digital certificate (e.g., a digital certificate associated with a domain name) may attest to an association between: (i) a cryptographic value (e.g., a public key), and (ii) an entity and/or an identifier (e.g., a domain name) of an entity. In some cases, a digital certificate (e.g., a digital certificate associated with a domain name and/or a digital content file) may attest to an association between: (i) a cryptographic value, and (ii) an entity and/or an identifier of an entity (e.g., a domain name registrant and/or identifier of the domain name registrant, a publisher and/or the identifier of the publisher associated with the digital content file, and/or the like).

A digital certificate may include data asserting an association between a cryptographic value such as a public key and an entity (e.g., an owner, operator, registrant, and/or publisher) and/or an entity identifier (e.g., domain name) associated with the entity. For example, in some cases, the digital certificate may represent an assertion that the cryptographic value was associated with the entity and/or the entity identifier at a time of interest (e.g., during a validity period associated with the certificate, at an issuance time associated with the certificate, and/or at a publication time associated with a digital content file). As another example, in some cases, a digital certificate may assert that a cryptographic value was associated with the entity and/or the entity identifier at the certificate's issuance time. As another example, in some cases, a digital certificate may assert that a cryptographic value was associated with the entity and/or the entity identifier during the certificate's validity period. As another example, in some cases, a digital certificate may assert that a cryptographic value was associated with the entity and/or the entity identifier at a publication time (e.g., a digital content file's publication time).

In some cases, a digital certificate may be associated with a validity period (e.g., a validity period that decreases over time). In some cases, a digital certificate may become invalid after the validity period expires, unless the digital certificate is renewed. In some cases, a digital certificate may auto-renew (e.g., if one or more conditions are satisfied), be manually renewed (e.g., if one or more conditions are satisfied), and/or renewed using another process (e.g., if one or more conditions are satisfied).

Digital certificates may adhere to standards and/or protocols, such as the X.509 standard developed by the International Telecommunications Union (ITU), the PKIX standard developed by the Internet Engineering Task Force (IETF), and/or other standards or protocols. As another example, a digital certificate may be in the form of an attribute certificate, which may be in the form of a message digitally signed by a trusted third party, the content of which ties certain attributes (e.g., properties or characteristics that can be used to determine the appearance, state, and other qualities) of an entity to an identifier of the entity (e.g., legal name, common name, domain name, email address, username, account number, and/or the like, and/or by a cryptographic value such as a public key and/or a hash of a public key). Based on the disclosure herein, one of ordinary skill in the art would understand that the embodiments described herein may be similarly applied to other forms of digital assertions that may be issued, reissued, and/or revoked by an authority, including Resource Public Key Infrastructure (RPKI) information, digital credentials, and/or other assertions. An example of such the other such assertion is described in U.S. Pat. No. 10,033,535 (issued on Jul. 24, 2018 from U.S. application Ser. No. 15/071,408), incorporated herein by reference, which describes an assertion in a multifaceted assertion directory system.

In some cases, a trust provider system (e.g., a certificate status determination system, a CA system, and/or the like) may be configured to perform a trust provision operation based on domain name related information associated with a trust provision request (e.g., a certificate status request such an OCSP request, a certificate request for issuance of a digital certificate, and/or the like). The domain name related information may represent one or more of: (i) a change in domain name registration data, (ii) a domain name status (e.g., whether the domain name is on server hold, whether the domain name is pending delete, an accreditation and/or other status associated with the domain name, and/or the like), and/or (iii) an indication of whether a domain name is associated with abusive activity, such as with DNS abuse (e.g., whether the domain name is designated a specific blocklist, such as a real-time block list (RBL); whether the domain name is determined to be associated with abusive activity, for example based on designation of the domain name by a blocklist, crawled content data associated with the domain name, a status of the domain name and/or a nameserver associated with the domain name at a current time and/or at a time associated with designation of the domain name by a blocklist; and/or the like). For example, the domain name related information may relate to a domain name that is associated with the trust provision request, such as at least one or more of: (i) registrant information associated with the domain name (e.g., data representing a registrant name and/or profile associated with the domain name), (ii) registrant status information associated with the domain name (e.g., data representing whether the domain name is currently registered), (iii) registration period information associated with the domain name (e.g., data representing a registration creation date of the domain name, a registration expiration date of the domain name, a registration renewal date of the domain name, and/or the like), (iv) registration transfer data associated with the domain name (e.g., data representing whether the domain name has been transferred after a validity period associated with the digital certificate), (v) data representing whether the domain name is associated with one or more statuses (e.g., a hold status, an accreditation status, a registrant-asserted status, a status asserted by storing a certificate in the domain name registration data associated with the domain name, and/or the like), and/or (vi) data representing a change in registration information for domain name (e.g., change in registrant, change in registrar of record, etc.). In some cases, domain name related information used to perform trust provision operation(s) may be stored using one or more domain name system (DNS) records; for example, using one or more of a transport layer security authentication (TLSA) record, a Certificate Authority Authorization (CAA) record, a text (TXT) record, and/or the like. In some cases, at least a portion of the domain name related information is stored by a domain name registry system, domain name registrar system, by a CA system, a certificate status determination system, a trust provider system, and/or the like. In some cases, the trust provider system provides one or more data values represented by domain name related information in addition to a digital certificate status provided in response to a certificate status request and/or a digital certificate (e.g., a time-limited digital certificate) provided in response to a certificate request. For example, in some cases, the system may determine that one or more data values represented by domain name related information (e.g., data representing whether a domain name is associated with abusive activity) are not sufficient to determine that a digital certificate is invalid (e.g., to revoke a certificate) and/or to refrain from issuing (e.g., reissuing) a certificate. However, the system may nevertheless provide the data value(s) in response to the certificate status request and/or the certificate request to enable another device (e.g., a client device, certificate authority, etc.) to make a determination about whether to trust a digital certificate, to trust a domain name and/or digital content file associated with the digital certificate, and/or to reissue a digital certificate and/or extend the validity period of a digital certificate.

In some cases, a trust provider system may be configured to retrieve domain name related information using a registration data service, such as a Registration Data Directory Service (RDDS) (e.g., a WHOIS server and/or a Registration Data Access Protocol (RDAP) server) in order to perform one or more trust provision operations. An RDDS system may enable access to domain name related information associated with domain name(s) using an RDDS query (e.g., a WHOIS query and/or RDAP query). In some cases, a trust provider system may include and/or communicate with an RDDS system. In some cases, an RDDS system may provide information stored by one or more of a domain name registry system, a domain name registrar system, and/or another system with access to domain name related information.

In some cases, the techniques described herein enable using domain name related information to perform a trust provision operation (e.g., determine a certificate's revocation status based on an event represented by domain name related information associated with a corresponding domain name). In some cases, a trust provider system: (i) retrieves and/or receives domain name related information associated with a domain name, (ii) determines, based on the domain name related information, a status of a digital certificate associated with the domain name, (iii) receives a trust provision request (e.g., a certificate status request, a certificate request, and/or the like), (iv) determines that the trust provision request is associated with the domain name, (v) retrieves and/or receives the certificate status associated with the digital certificate, and/or (vi) determines a response to the trust provision request based on the certificate status. Determining the status may, for example, include determining that the digital certificate is valid, determining that the digital certificate is invalid (e.g., determining to revoke the digital certificate), and/or determining that the validity of the digital certificate is unknown.

For example, in some cases, determining a status for a digital certificate associated with a domain name includes: (i) determining, based on the domain name related information associated with the domain name (e.g. based on the DNS record(s) associated with the domain name), whether the domain name is unregistered, and (ii) determining the digital certificate status based on whether the domain name is registered. In some cases, a trust provider system may be configured to determine that a digital certificate is invalid and/or refrain from issuing the digital certificate based on determining that domain name related information associated with a domain name indicates that the domain name is not currently registered. In some cases, a trust provider system may determine the registration status of a domain name based on one or more DNS records associated with that domain name. For example, the trust provider system may determine that a domain name associated with a digital certificate is not currently registered based on determining that a DNS lookup for the associated domain name returns a “non-existent domain” (NXDOMAIN) response and/or based on retrieving information associated with the domain name that includes a status value indicating that the domain name is not registered (e.g., the DNS records are deleted or pending deletion). As another example, the trust provider system may determine that the domain name is not currently registered based on querying a DNS entity (e.g., registry, registrar, and/or reseller entity) in relation to the domain name and receiving a response indicating that the domain name's registration has expired.

As another example, in some cases, determining a status for a digital certificate associated with a domain name includes: (i) determining, based on the domain name related information associated with the domain name, a status associated with the domain name, and (ii) determining the digital certificate status based on the domain name status. The domain name status may, for example, represent whether the domain name has been transferred (e.g., after the certificate's issuance time), has been deleted, is associated with a required status (e.g., an accreditation status, a certificate-related status, and/or the like), has lost a required status (e.g., an accreditation status, a certificate-related status, and/or the like) after the certificate's issuance, and/or the like. In some cases, the domain name's status may be determined based on one or more DNS records associated with that domain.

As another example, in some cases, determining a status for a digital certificate associated with a domain name includes: (i) determining, based on the domain name related information associated with the domain name, whether the domain name is designated (e.g., by a blocklist, based on other information, and/or the like) as being abusive (e.g., as being associated with DNS abuse), and (ii) determining the digital certificate status based on whether the domain name is designated as being abusive. In some cases, determining whether a domain name is abusive is based on at least one of: (i) whether the domain name is designated by a blocklist, (ii) crawled content data associated with the domain name, or (iii) a nameserver associated with the domain name at a current time and/or a time associated with designation of the domain name by a blocklist. In some cases, a domain name's nameserver and/or nameserver history may be represented by one or more DNS records associated with that domain name.

As another example, in some cases, determining a status for a digital certificate associated with a domain name is based on one or more other considerations, for example based on consideration(s) determined based on the domain name related information associated with the domain name.

In some cases, determining a digital certificate status is based on domain name related information stored by, provided, and/or represented by one or more data sources. Examples of such data sources include a registry system, an RDDS system, a registrar system, DNS record(s), blocklist data, and/or other data sources including cybersecurity threat indicator information and/or feeds.

For example, a digital certificate status may be determined based on domain name related information stored by a registry system. Such domain name related information stored by a registry system may include information regarding domain name information (and/or changes thereto) such as, registrant, registrar of record, date of registration and/or re-registration, deletion, nameserver record, and/or other records stored by the registry for the domain name. Domain name related information may be obtained from the registry system directly (e.g., using the Extensible Provisioning Protocol (EPP) or other direct access mechanism or protocol) or indirectly via a system with authorization to access the registry for the domain name (e.g., the registrar of record for the domain name).

As another example, a digital certificate status may be determined based on domain name related information stored by a registrar system. Such domain name related information stored by a registrar system may include information regarding domain name information (and/or changes thereto) such as, registrant, registrar of record, date of registration and/or re-registration, deletion, nameserver record, and/or other records stored by the registrar for the domain name. Domain name related information may be obtained from the registrar system directly or indirectly via a system with authorization to access the registrar for the domain.

As another example, a digital certificate status may be determined based on domain name related information provided by an RDDS system. Such domain name related information stored by a RDDS system may include information regarding domain name information (and/or changes thereto) such as, registrant, registrar of record, date of registration and/or re-registration, deletion, nameserver record, and/or other records stored by the RDDS for the domain name. Domain name related information may be obtained from the RDDS system directly (e.g., by querying the RDDS) or indirectly via a system with authorization to access domain name related information stored by the RDDS system.

As another example, a digital certificate status may be determined based on domain name related information comprising one or more DNS records. DNS records include records such as: A record, AAAA record, CNAME record, MX record, TXT record, NS record, SOA record, SRV record, PTR record, SVCB record, and/or other DNS records.

As another example, a digital certificate status may be determined based on domain name related information comprising blocklist data (e.g., data represented by one or more real-time block lists (RBLs)). Block list data may include one or more domain names with indications of DNS abuse (e.g., malware, botnets, phishing, pharming, spam when it serves as a delivery mechanism for other forms of DNS abuse) or other malicious behavior. Block list data may be obtained from one or more block list data sources.

As another example, a digital certificate status may be determined based on domain name related information stored on one or more other data sources.

As another example, a digital certificate status may be determined based on domain name related information indicated by a certificate revocation list (CRL) received from a CA. For example, in some cases, if a CRL indicates that a certificate is revoked, a trust provider system may determine that the certificate has an invalid status.

In some cases, determining the response to the trust provision request may include determining not to issue (e.g., to not reissue, for example after a period of time) a digital certificate based on determining that the domain name related information indicates that the that the domain name is not registered, the domain name has been transferred (e.g., after the certificate's issuance time), the domain name is not associated with a required status (e.g., an accreditation status, a certificate-related status, and/or the like) and/or has lost a required status (e.g., after the certificate's issuance time), and/or the like.

In some cases, a trust provider system may be configured to determine that a digital certificate is invalid (e.g., revoke the digital certificate) and/or refrain from issuing (e.g., reissuing) the digital certificate based on determining that domain name related information associated with a domain name indicates that the domain name has been transferred (e.g., after a time associated with issuance of the digital certificate). For example, the trust provider system may determine that a domain name associated with a digital certificate has been transferred based on retrieving a DNS TLSA record associated with the domain name that includes a transfer date value representing a transfer date after a time (e.g., an issuance time) associated with the digital certificate. As another example, the trust provider system may determine that the domain name has been transferred based on querying an RDAP server and receiving a response indicating that the domain name's registrant has changed after the relevant certificate time.

In some cases, a trust provider system may be configured to determine that a digital certificate is invalid and/or refrain from issuing the digital certificate based on determining that domain name related information associated with a domain name indicates that the domain name is not associated with one or more required statuses. For example, the trust provider system may determine that a domain name associated with a digital certificate is not associated with a required accreditation status (e.g., a trademark-related status, an accreditation associated with a professional organization, a security-related and/or compliance accreditation, and/or the like) based on retrieving a DNS Certificate Authority Authorization (CAA) record associated with the domain name and determining that the CAA record does not include a field value corresponding to a required accreditation status. As another example, the trust provider system may determine that the domain name is not associated with a required certificate storage status based on querying a WHOIS server in relation to the domain name and receiving a response indicating that a field corresponding to a required accreditation status is set to false.

As described above, a trust management system may determine domain name related information using an RDDS system and determine a trust management response based on the determined domain name related information. For example, a CA system may receive a certificate request representing a domain name and a certificate signing request (CSR). The CA system may then communicate with an RDDS system to retrieve domain name related information associated with the domain name by sending an RDDS query including the domain name to the RDDS system. The RDDS system may then respond to the query by providing the domain name related information associated with the domain name, such as the domain name's registrant, registration status, registration period, and/or the like. As another example, a certificate status determination system may receive a certificate status request representing a digital certificate. The certificate status determination system may extract a domain name from the digital certificate and communicate with an RDDS system to retrieve domain name related information associated with the domain name. The RDDS may then respond to the query by providing the domain name related information associated with the domain name.

In some cases, a trust provider system may use domain name related information retrieved using an RDDS system to determine a response to a trust provision request. For example, a CA system may determine whether to issue or reissue a digital certificate based on domain name related information retrieved using an RDDS system. The CA system may refrain from issuing the digital certificate if the retrieved domain name related information indicates that the domain name associated with the certificate request is not currently registered, has been transferred after a time associated with the digital certificate, and/or is not associated with one or more required statuses (e.g., an accreditation status, a security and/or compliance status, and/or the like). As another example, a certificate status determination system may determine a status for a digital certificate based on domain name related information retrieved using an RDDS system. For example, certificate status determination system may determine that the digital certificate is invalid (e.g., may revoke the digital certificate) if the retrieved domain name related information indicates that the domain name associated with the digital certificate is not currently registered, has been transferred after a time associated with the digital certificate, and/or is not associated with one or more required statuses (e.g., an accreditation status, a security and/or compliance status, and/or the like).

In some cases, the techniques described herein may enhance the security of digital environments by enabling trust provider systems to perform trust provision operations based on current and/or authoritative domain name related information. By using domain name related information to determine a status for and/or issue digital certificates, trust provider systems may reduce the risk of unauthorized entities obtaining and/or using digital certificates to misrepresent their association with a domain name. For example, a CA system may refrain from issuing a digital certificate for a domain name if domain name related information indicates that the domain name is not currently registered and/or is not associated with a certificate request's registrant, which may prevent an unauthorized entity from obtaining a digital certificate associated with the domain name. As another example, a certificate status determination system may determine that a digital certificate associated with a domain name is invalid if the relevant domain name related information indicates that the domain name has been transferred to a new registrant after the certificate's issuance, which may prevent an unauthorized entity from continuing to use the digital certificate to misrepresent association with the domain name. By performing trust provision operations based on current and/or authoritative domain name related information, trust provider systems may improve the reliability and/or security of digital certificates and/or may enhance the security of digital environments that rely on digital certificates for authentication and/or secure communication.

In some cases, combining a trust provider system (e.g., a CA system, a certificate status determination system, and/or the like) and a domain name server (e.g., a registry system, a registrar system, an RDDS system, and/or the like) may increase efficient use of computational and/or storage resources. For example, by combining a CA system and a domain name server, the CA system may be able to access domain name related information without needing to send queries over a network to a separate domain name server, which may reduce network latency and/or conserve network bandwidth. As another example, by combining a certificate status determination system and a domain name server, the certificate status determination system may be able to access domain name related information from a local storage device rather than retrieving the data from a remote storage device, which may reduce storage access latency and/or conserve network bandwidth. In some cases, combining a trust provider system and a domain name server may enable the trust provider system to access domain name related information using more efficient data retrieval and/or storage techniques, such as using a common database management system, a common caching system, a common indexing system, and/or the like. By combining a trust provider system and a domain name server, the trust provider system may be able to perform trust provision operations more efficiently and/or with reduced latency, which may improve the performance and/or scalability of the trust provider system.

In some cases, issuing a digital certificate and/or the determining the status of a digital certificate may enable establishment of a secure communication channel between two devices, such as between a web server and a client device (e.g., a web browser). A secure communication channel may be an encrypted connection that allows the two devices to exchange information. The secure communication channel may be established using protocols such as SSL and/or TLS.

In some cases, to establish a secure communication channel, a web server may be configured to perform the following operations: (i) provide the digital certificate to a client device requesting a secure communication session; (ii) receive, from the client device, a message encrypted using a public key associated with the digital certificate; and (iii) send, to the client device, a message encrypted using a symmetric key established based on the secure communication session. However, a person of ordinary skill in the relevant technology will recognize that a secure communication channel may be established with digital certificates using other techniques and/or protocols. The client device may determine a status for the digital certificate by performing one or more status determination operations, which may include: (i) verifying the digital signature of the certificate using the issuing CA's public key; (ii) verifying the expiration date of the certificate to determine that the certificate is not expired; (iii) verifying the revocation status of the certificate to determine that the certificate is valid (e.g., not revoked); and (iv) verifying that the domain name(s) specified in the certificate match the domain name of the web server. If the status determination operations are successful, the client device may generate a symmetric key, encrypt the symmetric key using the public key associated with the web server's digital certificate, and send the encrypted symmetric key to the web server. The web server may then decrypt the symmetric key using its corresponding private key and use the symmetric key to encrypt and decrypt the subsequent communication with the client device. Additionally, the client device may send a message encrypted using the public key associated with the digital certificate to cause authentication of the client device to the web server.

Examples of trust provision operations that may be performed in accordance with the techniques described herein include determining a status for a digital certificate and/or determining whether to issue a digital certificate, as further described below. However, a person of ordinary skill in the relevant technology will recognize that other trust provision operations may be performed based on domain name related information and using the techniques described herein.

### Example Digital Certificate Status Determination Techniques

In some cases, the techniques described herein enable a certificate status determination system (e.g., an OCSP responder system) to determine a status for a digital certificate based on domain name related information associated with the digital certificate. Determining a status for a digital certificate may include determining a revocation status associated with the digital certificate and/or providing the revocation status to a requester. A revocation status may represent whether the digital certificate has been revoked (e.g., by the issuing CA, based on changes in the domain name related information associated with the certificate, and/or the like). In some cases, a revocation status may indicate that a digital certificate is revoked, that a digital certificate is not revoked, and/or that the revocation state of the digital certificate is unknown. In some cases, if a digital certificate attests to an association between a public key and two or more entities and/or entity identifiers, the certificate's status may include statuses for a subset (e.g., one or more) and/or all of those association attestations. An example of a digital certificate that attests to the association of a public key with two or more entities and/or entity identifiers is a Secure Telephone Identity Revisited (STIR) certificate that attests to the association of a public key with two or more telephone numbers.

In some cases, the certificate status determination system may receive a certificate status request (e.g., an OCSP request) including data representing a digital certificate for which to determine a status. The digital certificate may include data representing an attestation of the association between a domain name and an entity. The certificate status determination system may receive and/or retrieve domain name related information associated with the domain name. The certificate status determination system may determine a status for the digital certificate based on the retrieved domain name related information.

For example, the certificate status determination system may determine that the domain name related information indicates that the domain name associated with the digital certificate has been transferred to a different registrant after the digital certificate's issuance time. In this example, the certificate status determination system may provide a certificate status response (e.g., an OCSP response) indicating that the digital certificate is not valid (e.g., is revoked).

As another example, the certificate status determination system may determine that the domain name related information indicates that the domain name associated with the digital certificate is not currently registered. In this example, the certificate status determination system may provide a certificate status response (e.g., an OCSP response) indicating that the digital certificate is not valid.

As another example, the certificate status determination system may determine that the domain name related information indicates that the domain name associated with the digital certificate is not associated with a required status (e.g., a required accreditation status) and/or has lost a required status. In this example, the certificate status determination system may provide a certificate status response (e.g., an OCSP response) indicating that the digital certificate is not valid.

In some cases, a certificate status determination system may be configured to receive a request for determining a status for a digital certificate associated with a digital content file. The system may then be configured to: (i) determine a domain name and a timestamp (e.g., a content publication timestamp) associated with the digital certificate, and/or (ii) determine, based on domain name related information associated with the domain name at the timestamp, a status for the digital certificate.

For example, the certificate status determination system may determine that the domain name related information indicates that the domain name was registered to the entity associated with the digital certificate at the timestamp. In this example, the certificate status determination system may provide a status response (e.g., an OCSP response) indicating that the digital certificate is valid (e.g., is not revoked). As another example, the certificate status determination system may determine that the domain name related information indicates that the domain name was not registered to the entity associated with the digital certificate at the relevant timestamp. In this example, the certificate status determination system may provide a status response indicating that the digital certificate is not valid.

In some cases, the certificate status determination system may be configured to determine a status for a digital certificate associated with a digital content file based on domain name related information indicating that the domain name was registered to the entity associated with the digital certificate at a time that the digital content file was published. This may enable the certificate status determination system to validate that the digital content file was associated with the entity at the time of publication, even if the entity's domain name has since been transferred to a different registrant and/or is no longer active.

In some cases, the certificate status request may be configured to receive a certificate status request. The certificate status request may include data representing a digital certificate. The certificate status request may be an OCSP request. The certificate status determination system may parse the certificate status request to extract data representing the digital certificate. The certificate status determination system may then determine, based on the extracted data, at least one of a domain name, an entity, a CA system, a validity period (e.g., an issuance time and/or expiration time), and/or the like) associated with the certificate, and/or a public key and/or other attribute(s) associated with the certificate. In some cases, the certificate status request may be provided using a DNS query, using a Hyper-Text Transfer Protocol Secure (HTTPS) request, and/or the like.

In some cases, the certificate status determination system may be configured to retrieve domain name related information associated with a domain name, for example from an RDDS system (e.g., as described above). For example, the certificate status determination system may be configured to provide data representing a domain name associated with a digital certificate to the RDDS system. The certificate status determination system may then receive, from the RDDS system, the domain name related information associated with the domain name. The domain name related information may, for example, represent a current registrant, a registration date, a registration period, a registration expiration date, a registration transfer date, and/or a status (e.g., an accreditation status) associated with a domain name.

In some cases, the certificate status determination system may determine a status for a digital certificate based on the domain name related information associated with the associated domain name. For example, the certificate status determination system may determine whether the certificate holder entity associated with the certificate matches the current registrant of the domain name, whether the validity period associated with the digital certificate is before the domain name transfer date, whether the CA associated with the digital certificate is an authorized CA for the domain name (e.g., as represented by the domain name related information, such as based on a DNS record), and/or the like. In some cases, the certificate status determination system may determine a status for the digital certificate if (e.g., among other conditions) the entity associated with the digital certificate matches the current registrant of the domain name, the validity period associated with the digital certificate is before the domain name transfer date, and the certificate authority associated with the digital certificate is authorized to issue digital certificates for the domain name. In some cases, if any of the conditions are not met, the certificate status determination system may determine that the digital certificate is invalid.

The certificate status determination system may provide a certificate status response based on the determined certificate status. If the certificate status determination system determines that the digital certificate is valid, the certificate status determination system may provide a certificate status response indicating that the digital certificate is valid. If the certificate status determination system determines that the digital certificate is invalid, the certificate status determination system may provide a certificate status response indicating that the digital certificate is invalid. The certificate status response may be an OCSP response. In some cases, the certificate status response may be provided using a DNS response, using an HTTPS response, and/or the like.

For example, the certificate status determination system may receive certificate status request (e.g., an OCSP request) including data representing a digital certificate associated with the domain name “example.com”. The certificate status determination system may extract or determine the domain name “example.com”, the entity “Example Inc.”, the certificate authority “Example CA”, and the certificate issuance time, such as the time and/or day of issuance, “2023-04-01T12:00:00Z” from the digital certificate. The certificate status determination system may retrieve domain name related information associated with the domain name “example.com” from one or more data sources. When the domain name-related information is domain name registration data, the data may indicate that the current registrant of the domain name is “Example Inc.”, the domain name registration date is “2022-01-01”, the domain name expiration date is “2024-01-01”, and the domain name transfer date is “2023-03-01”. The certificate status determination system may determine that the entity “Example Inc.” matches the current registrant, the certificate issuance time, such as the time and/or day of issuance, “2023-04-01T12:00:00Z” is within the domain registration date and the domain expiration date, the certificate issuance time, such as the time and/or day of issuance, is after the domain name transfer date, and the certificate authority “Example CA” is authorized to issue digital certificates for the domain name “example.com”. The certificate status determination system may determine a valid status for the digital certificate and provide a certificate status response (e.g., an OCSP response) indicating that the digital certificate status is valid.

As another example, the certificate status determination system may receive a certificate status request (e.g., an OCSP request) including data representing a digital certificate associated with the domain name “example.org”. The certificate status determination system may extract or determine the domain name “example.org”, the entity “Example LLC”, the certificate authority “Example CA”, and the certificate issuance time “2023-02-01T12:00:00Z” from the digital certificate. The certificate status determination system may retrieve domain name related information associated with the domain name “example.org” using an RDDS system. When the domain name-related information is domain name registration data, the data may indicate that the current registrant of the domain name is “Example Corp.”, the domain name registration date is “2022-01-01”, the domain name expiration date is “2024-01-01”, and the domain name transfer date is “2023-03-01”. The certificate status determination system may determine that the entity “Example LLC” does not match the current registrant “Example Corp.”. The certificate status determination system may determine an invalid status for the digital certificate and provide a certificate status response (e.g., an OCSP response) indicating that the digital certificate status is not valid (e.g., revoked).

Accordingly, the certificate status determination system may perform various operations to determine a status for a digital certificate based on domain name related information. For example, the certificate status determination system may receive a certificate status request, extract data from the digital certificate, determine a status for the digital certificate based on the domain name related information, and provide a certificate status response based on the determination. By performing these operations, the certificate status determination system may enhance the security and trustworthiness of digital certificates and/or prevent the use of fraudulent and/or invalid certificates. In this way, the techniques described herein may enhance the security and/or reliability of digital environments.

### Example Certificate Issuance Techniques

In some cases, the techniques described herein enable a CA system to determine whether to issue or reissue a digital certificate (e.g., a time-limited certificate) based on domain name related information associated with a certificate request. A time-limited certificate may be a digital certificate that is associated with a validity period. A certificate may be issued or reissued based on a manual process, an automatic process, such as in an automatic certificate management environment (ACME) for short-term auto-renewing (STAR) certificates, as described in RFC8739, and/or another process. In some cases, instead of and/or in addition to enabling determination of the status of a digital certificate using the operation(s) performed by a certificate status determination system (e.g., OCSP system), the techniques described herein enable imposing a time limit (e.g., time limit that falls below a threshold, such as predetermined number of months, weeks, days, hours, minutes, seconds, etc.) on a digital certificate and requiring periodic renewal of the digital certificate. In some cases, using a time-limited digital certificate may reduce and/or eliminate the need for performing certificate status determination, as an invalid certificate will lose its valid status with the passage of time and will not be reissued. In some cases, to determine whether to issue or reissue a digital certificate (e.g., a time-limited certificate), a CA system may use domain name related information, for example using the techniques described herein. In some cases, a validity period associated with a digital certificate may decrease over time. In some cases, a digital certificate may become invalid after the validity period expires, unless the digital certificate is renewed. In some cases, a digital certificate may auto-renew (e.g., if one or more conditions are satisfied), be manually renewed (e.g., if one or more conditions are satisfied), and/or renewed using another process (e.g., if one or more conditions are satisfied).

In some cases, a CA system is configured to: (i) receive a certificate request from a requestor, (ii) determine a domain name associated with the request, (iii) receive and/or retrieve domain name related information associated with the domain name, and/or (iv) determine whether to issue or reissue a certificate (e.g., a time-limited certificate) in response to the received certificate request based on the domain name related information. For example, the CA system may determine that the domain name related information indicates that that the domain name was registered to an entity associated with the certificate request. In this example, the CA system may determine to issue a digital certificate. As another example, the CA system may determine that the domain name related information indicates that the domain name was not registered to an entity associated with the certificate request. In this example, the CA system may determine to refrain from issuing the digital certificate.

In some cases, a CA system may be configured to receive a request for issuing a digital certificate associated with a digital content file. The system may then be configured to: (i) determine a domain name and a timestamp (e.g., a content publication timestamp) associated with the digital content file, and/or (ii) determine, based on domain name related information associated with the domain name at the timestamp, whether to issue the digital certificate. For example, the CA system may determine that the domain name related information indicates that the domain name was registered to the entity associated with the request at the timestamp. In this example, the CA system may determine to issue the digital certificate. As another example, the CA system may determine that the domain name related information indicates that the domain name was not registered to the entity associated with the request at the timestamp. In this example, the CA system may determine to refrain from issuing the digital certificate.

In some cases, a CA system may be configured to determine whether to issue or reissue a digital certificate (e.g., a time-limited certificate) for a domain name based on domain name related information indicating that the domain name is associated with a required registrant profile. For example, the CA system may retrieve the domain name related information from a data source and determine whether a registrant identifier included in the domain name related information matches a registrant identifier associated with the certificate request. If the registrant identifiers match, the CA system may determine to issue the digital certificate. If the registrant identifiers do not match, the CA system may determine to refrain from issuing the digital certificate.

In some cases, a CA system may be configured to determine whether to issue or reissue a digital certificate (e.g., a time-limited certificate) for a domain name based on domain name related information indicating that the domain name has not been transferred after a timestamp associated with the certificate request. For example, the CA system may retrieve domain name related information associated with the domain name and determine whether the domain name related information includes a transfer date indicating that the domain name has been transferred after the timestamp associated with the certificate request. If the domain name related information does not include a transfer date after the timestamp, the CA system may determine to issue the digital certificate. If the domain name related information includes a transfer date after the timestamp, the CA system may determine to refrain from issuing the digital certificate.

In some cases, a CA system may receive a certificate request (e.g., a certificate signing request (CSR)) representing a domain name. The CA system may extract the domain name from the certificate request and retrieve domain name related information associated with the domain name, for example using a domain name related information retrieval protocol such as RDDS. The domain name related information may include information such as a registration status, a registrant, a registration period, and/or an accreditation status associated with the domain name. The CA system may then determine whether to issue or reissue a digital certificate in response to the certificate request based on the retrieved domain name related information.

For example, the CA system may determine that the certificate should be issued if the domain name related information indicates that the domain name is registered to an entity that matches an entity associated with the certificate request (e.g., the CSR sender entity), the domain name has not been transferred after a date associated with the certificate request, and/or the domain name has a required status (e.g., a required accreditation status). The CA system may determine that the certificate should not be issued if the domain name related information indicates that the domain name is not registered, the domain name is not registered to an entity that matches the entity associated with the entity, the domain name has been transferred after a date associated with the certificate request, and/or the domain name does not have a required status. If the CA system determines to issue the digital certificate, the CA system may generate a digital certificate (e.g., an X.509 certificate) for the domain name. The CA system may set a validity period for the digital certificate based on a validity period policy and/or the domain name's registration expiration date. For example, the CA system may set the digital certificate's validity period to a predetermined time period (e.g., 90 days) and/or may set the digital certificate's validity period to end before the domain name's registration expiration date. The CA system may sign the digital certificate using the CA system's private key and/or may return the signed digital certificate to the requestor.

In some cases, by using domain name related information to determine a status for a certificate request, a CA system may verify that the certificate request is authorized by the current and/or authoritative registrant of the domain name. In this way, the techniques described herein may reduce and/or prevent issuance of digital certificates to unauthorized entities. By performing these operations, the certificate status determination system may enhance the security and trustworthiness of digital certificates and/or prevent the use of fraudulent and/or invalid certificates. Accordingly, the techniques described herein may enhance the security and/or reliability of digital environments.

### Example Implementations

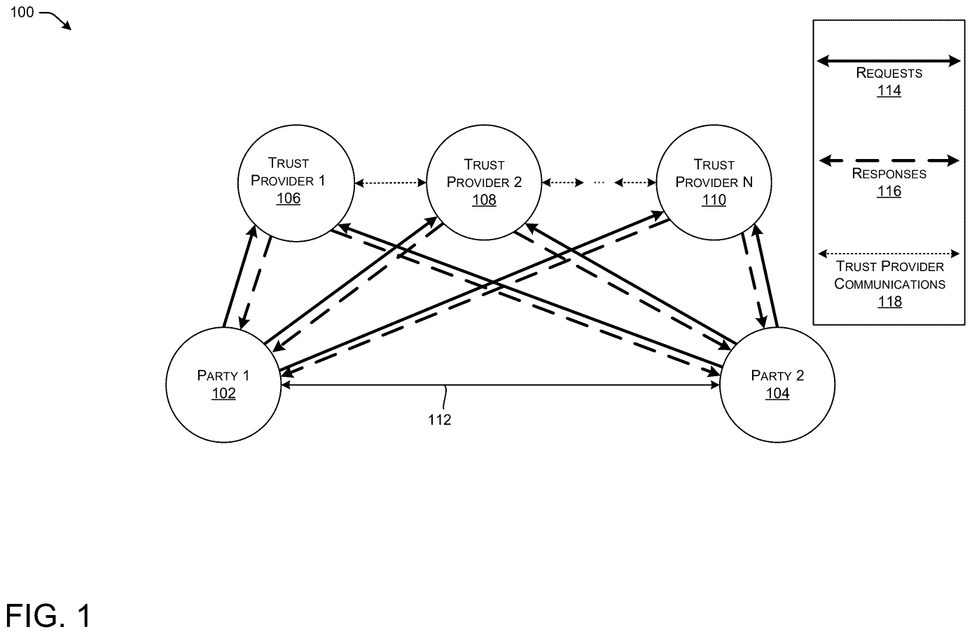

FIG. 1 provides an example digital environment 100 for performing one or more trust provision operations. As depicted in FIG. 1, the environment includes a first party system 102, a second party system 104, and a set of N trust providers, including a first trust provider system 106, a second trust provider system 108, and an Nth trust provider system 110.

The first party system 102 may, for example, be a system associated with an entity (e.g., a domain name registrant) that is linked to an electronic resource (e.g., a domain name, a digital content file, and/or the like). The second party system 104 may, for example, be a system (e.g., a client system) configured to request a digital certificate associated with the first party system 102 and/or request determining the status of a digital certificate associated with the first party system 102.

In some cases, a trust provider system may include: (i) a CA system configured to determine (e.g., based on domain name related information) whether to issue a digital certificate associated with an electronic resource (e.g., using the techniques described above), (ii) a certificate status determination system (e.g., OCSP responder system) configured to determine (e.g., based on domain name related information) a status for a digital certificate associated with an electronic resource (e.g., using the techniques described above), (iii) a domain name registration system (e.g., a domain name registry system, a domain name registrar system, an RDDS system, and/or the like) configured to store domain name related information (e.g., used to perform certificate issuance and/or certificate status determination determinations), and/or (iv) a timestamping authority configured to associate an electronic resource (e.g., a digital content file) with a timestamp (e.g., a publication timestamp).

In some cases, the first party system 102 and the second party system 104 may communicate using a set of cross-party communications 112. The cross-party communications 112 may, for example, include: (i) a request by the second party system 104 (e.g., as a client system) to obtain a digital certificate from the first party system 102 (e.g., as the server for the entity linked to the electronic resource, such as the domain name registrant server), (ii) a request by the second party system 104 (e.g., as a client system) to obtain a stapled certificate status response (e.g., a stapled OCSP response) from the first party system 102 (e.g., as the server for the entity linked to the electronic resource, such as the domain name registrant server), (iii) a digital certificate sent to the second party system 104 by the first party system 102, and/or (iv) a stapled status determination of a digital certificate sent to the second party system 104 by the first party system 102.

In some cases, one or more of the first party system 102 or the second party system 104 may send requests 114 to at least a subset of the N trust provider systems. The requests 114 may include certificate requests and/or certificate status requests (e.g., OCSP requests). In response to requests 114 by one or more of the first party system 102 or the second party system 104, the N trust provider systems may provide responses 116 to one or more of the first party system 102 or the second party system 104. The responses 116 may include digital certificates and/or certificate status responses.

For example, in some cases, the first party system 102 may transmit a request for a digital certificate to a trust provider system (e.g., to a CA system). The first party system 102 may then receive the digital certificate from the trust provider system, store the digital certificate, and transmit the digital certificate to the second party system 104 in response to a certificate request by the second party system 104.

As another example, in some cases, the first party system 102 may transmit a request for determining the status of a digital certificate to a trust provider system (e.g., an OCSP responder system). The first party system 102 may then receive a status response (e.g., OCSP response) from the trust provider system, store the status response, and transmit the status response to the second party system 104 in response to a certificate status request by the second party system 104.

As another example, in some cases, the second party system 104 may transmit a request for determining the status of a digital certificate to a trust provider system (e.g., an OCSP responder system). The second party system 104 may then receive a status response (e.g., OCSP response) from the trust provider system and determine whether the digital certificate is valid based on this received response.

In some cases, the N trust provider systems communicate with each other using a set of trust provider communications 118. The trust provider communications 118 may, for example, include: (i) a communication between a registry and another trust provider system (e.g., a CA system and/or a certificate status determination system) to provide domain name related information, (ii) a communication between a timestamping authority and another trust provider system (e.g., a CA system and/or a certificate status determination system) to provide a timestamp associated with an electronic resource (e.g., a digital content file), (iii) a communication between a CA system and a certificate status determination system to provide information about issued digital certificates and/or invalid (e.g., revoked) digital certificates, and/or (iv) a communication between a first trust provider system and a second trust provider system to relay a request and/or a response between the first party system 102 and the second party system 104.

In some implementations, a trust provider system may use domain name related information to perform one or more trust provision operations. For example, a CA system may use domain name related information to determine whether to issue or reissue a digital certificate in response to a certificate request (e.g., a CSR). As another example, a certificate status determination system may use domain name related information to determine a status for a digital certificate in response to a certificate status request (e.g., an OCSP request).

A trust provider system may obtain domain name related information from a domain name registration system, such as a registry. The domain name registration system may be a system configured to maintain domain name registration records. The domain name registration records may include information such as domain name registrant information, domain name registration status, domain name registration dates (e.g., creation date, expiration date, renewal date, and/or the like), domain name transfer information, and/or the like.

In some cases, a trust provider system may communicate with the domain name registration system to obtain domain name related information in response to a received request (e.g., a certificate request and/or a status request) associated with a domain name. For example, a CA system may receive a certificate request for a domain name. The CA system may then communicate with the domain name registration system to obtain domain name related information for the domain name. The CA system may use the obtained domain name related information to determine whether to issue or reissue a digital certificate for the domain name.

As another example, a certificate status determination system may receive a status request for a digital certificate associated with a domain name. The certificate status determination system may then communicate with the domain name registration system to obtain domain name related information for the domain name. The certificate status determination system may use the obtained domain name related information to determine a status for the digital certificate.

In some implementations, a trust provider system may periodically obtain domain name related information from the domain name registration system and store the obtained domain name related information in a local database. The trust provider system may then use the locally stored domain name related information to perform trust provision operations, for example without needing to communicate with the domain name registration system in response to each request.

A trust provider system may also communicate with other trust provider systems to perform trust provision operations. For example, a CA system may communicate with a timestamping authority to obtain a timestamp to include in a digital certificate. The timestamp may indicate a time at which the digital certificate was issued. As another example, a certificate status determination system may communicate with a CA system to obtain information about issued digital certificates and/or invalid (e.g., revoked) digital certificates. The certificate status determination system may use this information to determine a status for a digital certificate in response to a status request.

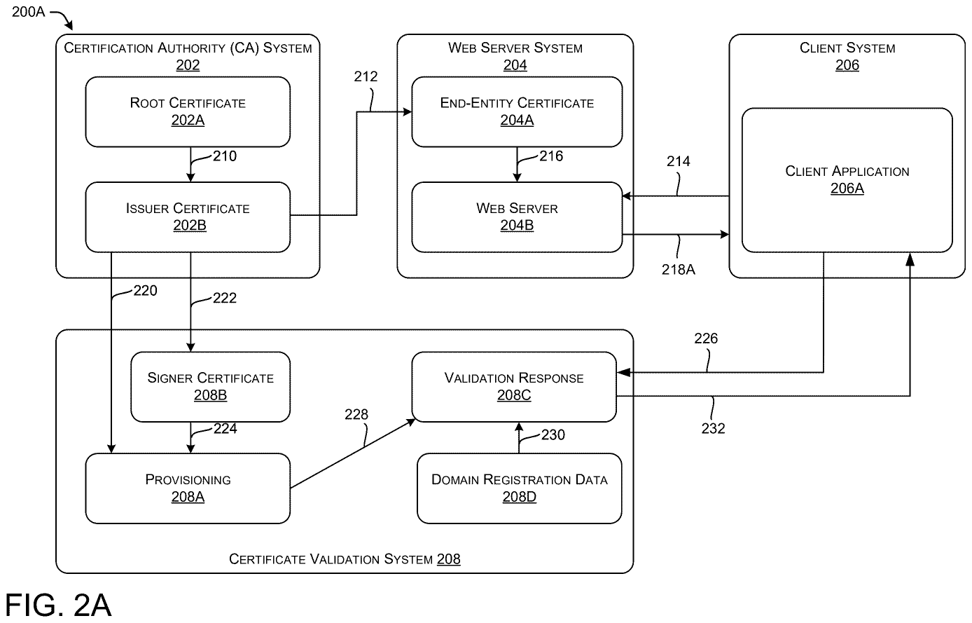

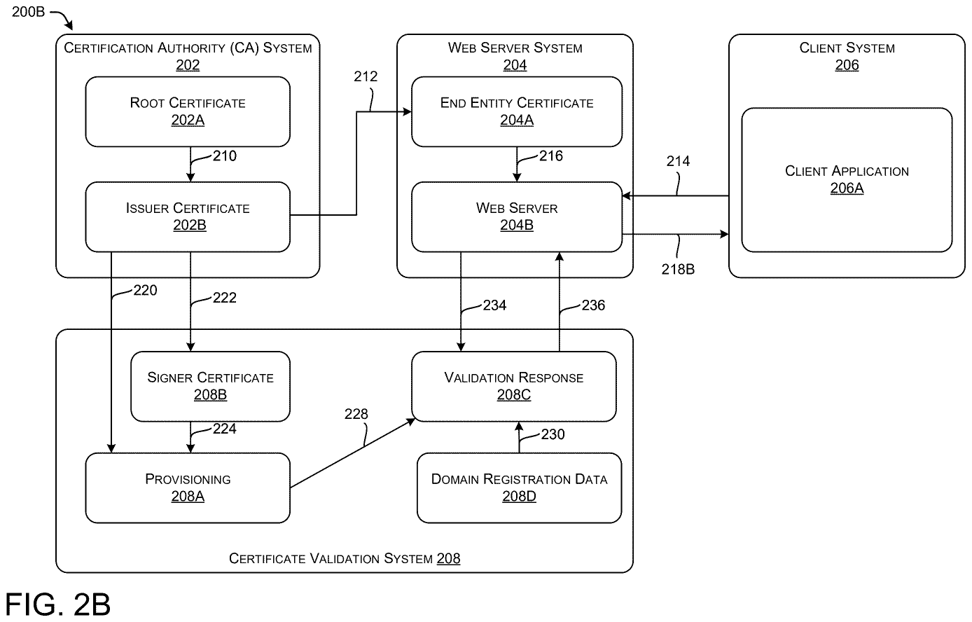

FIG. 2A provides an example process 200A for issuing and determining a status for a digital certificate without using stapled status responses. As depicted in FIG. 2A, at operation 210, a CA system 202 generates an issuer certificate 202B cryptographically signed by a root certificate 202A. The root certificate 202A may be a self-signed certificate that serves as the trust anchor for the CA system 202. The issuer certificate 202B may be used by the CA system 202 to sign other certificates, such as end-entity certificates.

At operation 212, the CA system 202 generates an end-entity certificate 204A for a web server system 204 based on the issuer certificate 202B. In some cases, the CA system 202 may first receive a certificate request (e.g., CSR) from the web server system 204. The certificate request may, for example, include information such as the domain name and/or the public key associated with the web server system 204. In some cases, in response to the certificate request, the CA system 202 may sign the end-entity certificate 204A using the issuer certificate 202B. The end-entity certificate 204A may, for example, include information such as the domain name, the public key, and/or validity period of the end-entity certificate 204A. After receiving the end-entity certificate 204A, the web server system 204 may, at operation 216, store the end-entity certificate 204A. The web server system 204 may, for example, be a server associated with a domain name registrant.

At operation 214, the web server system 204 receives a certificate request from a client application 206A (e.g., a web browser) on a client system 206. The certificate request may, for example, be a request to establish a secure connection between the client system 206 and the web server 204B.

At operation 218A, the web server 204B retrieves the end-entity certificate 204A to the client application 206A. Operations 214 and/or 218A may, for example, be part of a handshake (e.g., a TLS handshake) between the web server 204B and the client application 206A. After receiving the end-entity certificate 204A, the client application 206A may perform a verification of the end-entity certificate 204A. The verification may include, for example, verifying the certificate's signature, verifying the certificate's chain of trust up to the root certificate 202A, and/or verifying the certificate's validity period is not expired. In some cases, verifying the end-entity certificate 204A may include one or more of: (i) verifying that the end-entity certificate 204A is cryptographically signed by a trusted issuer certificate (e.g., the issuer certificate 202B), (ii) verifying that the issuer certificate 202B is cryptographically signed by a trusted root certificate (e.g., the root certificate 202A, (iii) verifying that the end-entity certificate 204A is not expired, and/or (iv) verifying that the end-entity certificate 204A is not valid (e.g., is revoked). The client application 206A may also verify that the domain name specified in the certificate matches the domain name of the web server 204B that the client application 206A is attempting to connect to. If any of these verification checks fail, the client application 206A may terminate the connection and/or display a security warning to the user.

At operation 220, the CA system 202 provides data about revocation of digital certificate(s) to a provisioning component 208A of the certificate status determination system 208. The revocation data may, for example, include a certificate revocation list (CRL).

At operation 222, the CA system 202 provides a signer certificate 208B to the certificate status determination system 208. The signer certificate 208B may, for example, be cryptographically signed by the issuer certificate 202B. In some cases, the signer certificate 208B includes a public key associated with the CA system 202, an identifier of the CA system 202, a serial number, and/or an identifier of the certificate status determination system 208. In some cases, the private key associated with the signer certificate 208B is stored in the certificate status determination system 208.

At operation 224, the provisioning component 208A uses the signer certificate 208B and/or certificate revocation data to determine whether a digital certificate is valid. For example, the provisioning component 208A may determine whether the end-entity certificate 204A is included in a CRL provided by the CA system 202. If the end-entity certificate 204A is not included in the CRL, the certificate status determination system 208 may determine that the end-entity certificate 204A is valid. If the end-entity certificate 204A is included in the CRL, the certificate status determination system 208 may determine that the end-entity certificate 204A is not valid. In some cases, the provisioning component 208A may periodically update the revocation data (e.g., CRL data) received from the CA system 202.

At operation 226, the client application 206A sends a certificate status request associated with a digital certificate to a status response component 208C of the certificate status determination system 208. The client application 206A may send the certificate status request to determine whether the end-entity certificate 204A is valid. The certificate status request may, for example, be OCSP request. The OCSP request may include information such as the serial number of the end-entity certificate 204A and/or the identifier of the CA system 202 that issued the end-entity certificate 204A.

At operation 228, the status response component 208C receives the status determination result generated by the provisioning component 208A. The status determination result may describe a determination about whether a digital certificate, for example as determined based on certificate revocation data (e.g., a CRL) provided by the CA system 202.

At operation 230, the status response component 208C receives domain name related information 208D. The domain name related information 208D may, for example, represent a registration status, a registrant, a registration period, and/or an accreditation status associated with a domain name corresponding to a digital certificate. For example, the domain name related information 208D may represent whether a domain name associated with the end-entity certificate 204A is registered and/or a current registrant associated with that domain name. In some cases, the status response component 208C periodically retrieves the domain name related information 208D.

At operation 232, the status response component 208C generates a status response based on the status determination result received from the provisioning component 208A and the domain name related information 208D. The status response may indicate whether the end-entity certificate 204A is valid, invalid (e.g., revoked), and/or is associated with an unknown status. The status response may include additional metadata, such as a timestamp for when the status determination was performed, the serial number of the digital certificate whose status is being determined, an identifier of the certificate status determination system 208, and/or an identifier of the CA system 202. The status response may be cryptographically signed using the private key associated with the signer certificate 208B. Example techniques for determining a status for a digital certificate based on domain name related information are described above.

At operation 234, the status response component 208C sends the signed status response to the client application 206A on the client system 206. The client application 206A may verify the status response by determining the response's digital signature against a public key associated with the signer certificate 208B and/or with the certificate status determination system 208. In some cases, after receiving the status response, the client application 206A processes the status response to determine whether to proceed with establishing a secure connection to the web server 204B. In some cases, if the status response indicates that the end-entity certificate 204A is valid, the client application 206A may establish an encrypted communication channel with the web server 204B. In some cases, if the status response indicates that the certificate is invalid (e.g., revoked), the client application 206A may terminate the connection and/or display a warning message to the user.

FIG. 2B provides an example process 200B for issuing and determining a status for a digital certificate using stapled status responses. As depicted in FIG. 2B, the process 200B includes all of the operations of the process 200A, except: (i) the process 200B excludes operations 226, 232, and 218A, and (ii) the process 200B includes operation 234, operation 236, and operation 218B (e.g., instead of operation 218B).

At operation 234, the web server 204B provides a request for determining a status for the end-entity certificate 204A to the status response component 208C of the certificate status determination system 208. The status response component 208C may then determine the status response using the techniques described above. The determined status response may then be provided to the web server 204B at operation 236. Afterward, the web server 204B may store the received status response and provide the status response (e.g., along with the end-entity certificate 204A) to the client application 206A, in response to the request (e.g., the certificate request) received from the client application 206A at operation 214.

Collectively, operation 234, operation 236, and operation 218B may enable transmitting a stapled status response. As used herein, a stapled status response may may refer to a status response that is received from a web server (e.g., instead of a certificate status determination system) and/or associated with (e.g., attached to and/or included with) an end-entity certificate. In some cases, a stapled status response may be transmitted together with an end-entity certificate in response to a request for the end-entity certificate.

In some cases, sending stapled status responses may provide several advantages. For example, sending stapled status responses may reduce the number of round trips required to determine a status for an end-entity certificate. For example, in the process 200A, the client application 206A may need to send a separate status request to the certificate status determination system 208 after receiving the end-entity certificate 204A from the web server 204B. In contrast, in the process 200B, the web server 204B may obtain the status response from the certificate status determination system 208 in advance and include it with the end-entity certificate 204A when sending it to the client application 206A. This may allow the client application 206A to determine a status for the end-entity certificate 204A without the need to send a separate status request to the certificate status determination system 208, which may reduce the latency associated with certificate status determination.

In some cases, sending status responses may reduce the operational load on the certificate status determination system 208. In the process 200A, the certificate status determination system 208 may need to respond to a status request from each client application that wants to determine a status for an end-entity certificate. In contrast, in the process 200B, the certificate status determination system 208 may only need to respond to status requests from web servers, which may be less frequent than status requests from client applications. This may help to distribute the load of certificate status requests across multiple web servers and/or reduce the burden on the certificate status determination system 208.

In some cases (e.g., in an OSCSP over DNS implementation), the status response component 208C: (i) receives the status request using a DNS query, and/or (ii) sends a status response as part of a DNS response. For example, in an OCSP over DNS implementation, the web server 204B and/or the client application 206A may send a status request to the certificate status determination system 208 using a DNS query. The DNS query may include the domain name of the certificate status determination system 208 along with the serial number of the end-entity certificate 204A. The status response component 208C may receive the DNS query, extract the serial number of the certificate, and determine the status of the certificate using the certificate revocation data provided by the CA system 202. The status response component 208C may then generate a status response including the determined status of the certificate and send this response to the web server 204B and/or the client application 206A as part of a DNS response.

In some cases (e.g., in an OSCSP over HTTPS implementation), the status response component 208C: (i) receives the status request using an HTTPS request, and/or (ii) sends a status response as part of a HTTPS response. For example, in an OCSP over HTTPS implementation, the web server 204B and/or the client application 206A may send a status request to the certificate status determination system 208 using an HTTPS POST request. The POST request may include the serial number of the end-entity certificate 204A, along with the identifier of the CA system 202 that issued the certificate. The status response component 208C may receive the HTTPS POST request, extract the serial number of the certificate, and determine the status of the certificate using the certificate revocation data provided by the CA system 202. The status response component 208C may then generate a status response containing the determined status of the certificate and send the status response to the web server 204B and/or the client application 206A as part of an HTTPS response.

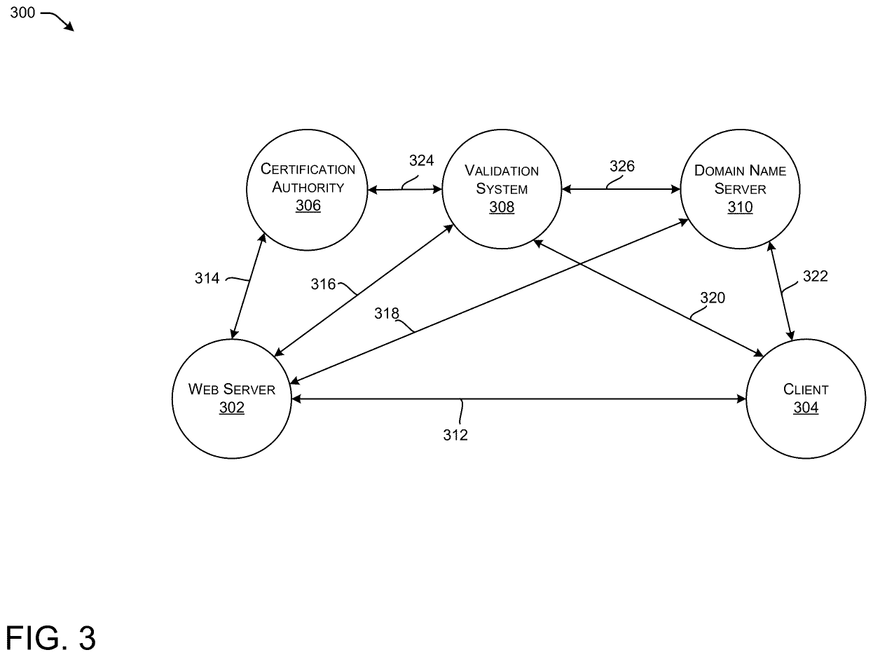

FIGS. 3-6 provide operational examples of three use cases of determining a certificate status response based on domain name related information. For example, FIG. 3 provides an operational example 300 of establishing a secure communication channel between a web server 302 and a client 304 using a CA system 306, a certificate status determination system 308, and a domain name server 310 (e.g., domain name registration system including a DNS server, a registry system, a registrar system, and/or the like).

As depicted in FIG. 3, at operation 312, the web server 302 and the client 304 establish a secure communication channel using a set of handshake operations. The set of handshake operations may, for example, including: (i) the client 304 sending a certificate request to the web server 302, (ii) the web server 302 sending a digital certificate to the client 304, and/or (iii) (e.g., in a stapled certificate status determination implementation) the web server 302 sending both a certificate and a status response to the client 304. The client 304 may verify the received certificate and/or certificate status response to determine whether the web server 302 is legitimately associated with an entity that the client 304 seeks to connect to. If this verification is successful, the client 304 may establish a secure communication channel with the web server 302.

At operation 314, the web server 302 obtains a digital certificate from the CA system 306. The web server 302 may provide a certificate request (e.g., a CSR) to the CA system 306. The CA system 306 may then determine whether to issue the digital certificate using one or more verification procedures. The verification procedures may include: (i) verifying whether the requester is associated with the domain name's registrant, (ii) verifying the request's digital signature using the registrant's public key, (iii) verifying whether the public key represented by the request is associated with one or more requirements (e.g., length requirement(s), cryptographic algorithm strength requirement(s), and/or the like), (iv) verifying that the requester is not on a blacklist, and/or the like. In some cases, the CA system 306 determines whether to issue the digital certificate based on domain name related information received from the domain name server 310. If the CA system 306 determines to issue the digital certificate, the CA system 306 may transmit data representing the digital certificate to the web server 302. In some cases, operation 314 is performed in implementations that use stapled digital certificates.

At operation 316, the web server 302 obtains a certificate status response (e.g., an OCSP response indicating that the certificate is valid) from the certificate status determination system 308. The web server 302 may provide a certificate status request (e.g., an OCSP request) to the certificate status determination system 308. The request may represent data associated with a digital certificate. The certificate status determination system 308 may then determine whether the digital certificate is valid using one or more verification procedures. The verification procedures may include: (i) verifying whether the digital signature's serial number corresponds to a valid certificate issued by the CA system 306, (ii) verifying the certificate's expiration date to determine that the certificate is valid, (iii) verifying the certificate's digital signature using the public key associated with the CA system 306, (iv) verifying whether the certificate is marked as invalid (e.g., revoked) based on revocation data (e.g., CRL data) received from the CA system 306, and/or the like. In some cases, the certificate status determination system 308 determines a status for a digital signature based on the domain name related information received from the domain name server 310. Afterward, the certificate status determination system 308 sends a certificate status response (e.g., OCSP response) indicating this status determination to the web server 302. In some cases, operation 316 is performed in implementations that use stapled certificate status responses.

At operation 318, the web server 302 obtains data from the domain name server 310. In some cases, operation 318 is performed in implementations that use stapled certificate status responses. In some cases, operation 318 is performed in implementations in which the digital certificate data and/or the certificate status response is provided over DNS, using a DNS response to a DNS query, and/or from the domain name server 310. For example, in some cases, the certificate status determination system 308 and the domain name server 310 are part of a system that is configured to: (i) receive a certificate status request from the web server 302, (ii) retrieve domain name related information associated with the request from the domain name server 310, (iii) determine a certificate status response based on the retrieved domain name related information (e.g., using the techniques described above), and/or (iv) provide the certificate status response to the web server 302. As another example, in some cases, the domain name server 310 is configured to: (i) receive a certificate status request from the web server 302, (ii) retrieve domain name related information associated with the request, (iii) receive, from the certificate status determination system 308, data representing a determination by the certificate status determination system 308 about whether the certificate is valid, (iv) determine a certificate status response based on the retrieved domain name related information (e.g., using the techniques described above) and/or based on the data received from the certificate status determination system 308, and/or (iv) provide the certificate status response to the web server 302. As another example, in some cases, the web server 302 is configured to: (i) provide a first certificate status request to the certificate status determination system 308 and a second certificate status request to the domain name server 310, (ii) receive a first certificate status response from the certificate status determination system 308 and/or in response to the first request, and/or (iii) receive a second certificate status response from the domain name server 310 and/or in response to the second request.

At operation 320, the client 304 obtains a certificate status response (e.g., an OCSP response indicating that the certificate is valid) from the certificate status determination system 308. The client 304 may first provide a certificate status request (e.g., an OCSP request) to the certificate status determination system 308. The request may represent data associated with a digital certificate. The certificate status determination system 308 may then determine whether the digital certificate is valid using one or more verification procedures (e.g., as described above). In some cases, the certificate status determination system 308 determines a status for a digital signature based on the domain name related information received from the domain name server 310. The certificate status determination system 308 may send a certificate status response (e.g., OCSP response) indicating this status determination to the client 304. In some cases, operation 320 is performed in implementations that use non-stapled certificate status responses.

At operation 322, the client 304 obtains data from the domain name server 310. In some cases, operation 322 is performed in implementations that use non-stapled certificate status responses. In some cases, operation 322 is performed in implementations in which the digital certificate data and/or the certificate status response is provided over DNS, using a DNS response to a DNS query, and/or from the domain name server 310. For example, in some cases, the certificate status determination system 308 and the domain name server 310 are part of a system that is configured to: (i) receive a certificate status request from the client 304, (ii) retrieve domain name related information associated with the request from the domain name server 310, (iii) determine a certificate status response based on the retrieved domain name related information (e.g., using the techniques described above), and/or (iv) provide the certificate status response to the client 304. As another example, in some cases, the domain name server 310 is configured to: (i) receive a certificate status request from the client 304, (ii) retrieve domain name related information associated with the request, (iii) receive, from the certificate status determination system 308, data representing a determination by the certificate status determination system 308 about whether the certificate is valid, (iv) determine a certificate status response based on the retrieved domain name related information (e.g., using the techniques described above) and/or based on the data received from the certificate status determination system 308, and/or (iv) provide the certificate status response to the client 304. As another example, in some cases, the client 304 is configured to: (i) provide a first certificate status request to the certificate status determination system 308 and a second certificate status request to the domain name server 310, (ii) receive a first certificate status response from the certificate status determination system 308 and/or in response to the first request, and/or (iii) receive a second certificate status response from the domain name server 310 and/or in response to the second request.

At operation 324, the CA system 306 and the certificate status determination system 308 may communicate with each other to facilitate the trust provision operation(s) performed by either or both of those components. These communications may include, for example: (i) transmitting certificate data from the CA system 306 to the certificate status determination system 308 (e.g., to update the status of newly issued certificates), (ii) providing revocation data (e.g., CRL data and/or real-time revocation event(s)) to the certificate status determination system 308, (iii) providing the public key of the CA system 306 to the certificate status determination system 308 and/or the public key of the certificate status determination system 308 to the CA system 306, and/or the like.

At operation 326, the certificate status determination system 308 may communicate with the domain name server 310. These communications may, for example, include: (i) transmitting a request for domain name related information from the certificate status determination system 308 to the domain name server 310, (ii) forwarding a certificate status request from the certificate status determination system 308 to the domain name server 310, (iii) sending a certificate status request generated by the domain name server 310 to the certificate status determination system 308 (e.g., for forwarding to a requester, such as to the web server 302 and/or the client 304), and/or (iv) providing domain name related information from the domain name server 310 to the certificate status determination system 308.

Additionally or alternatively, the CA system 306 may communicate with the domain name server 310. These communications may, for example, include: (i) transmitting a request for domain name related information from the CA system 306 to the domain name server 310, (ii) forwarding a certificate request from the CA system 306 to the domain name server 310, (iii) sending a digital certificate generated by the domain name server 310 to the CA system 306 (e.g., for forwarding to a requester, such as to the web server 302 and/or the client 304), and/or (iv) providing domain name related information from the domain name server 310 to the CA system 306.

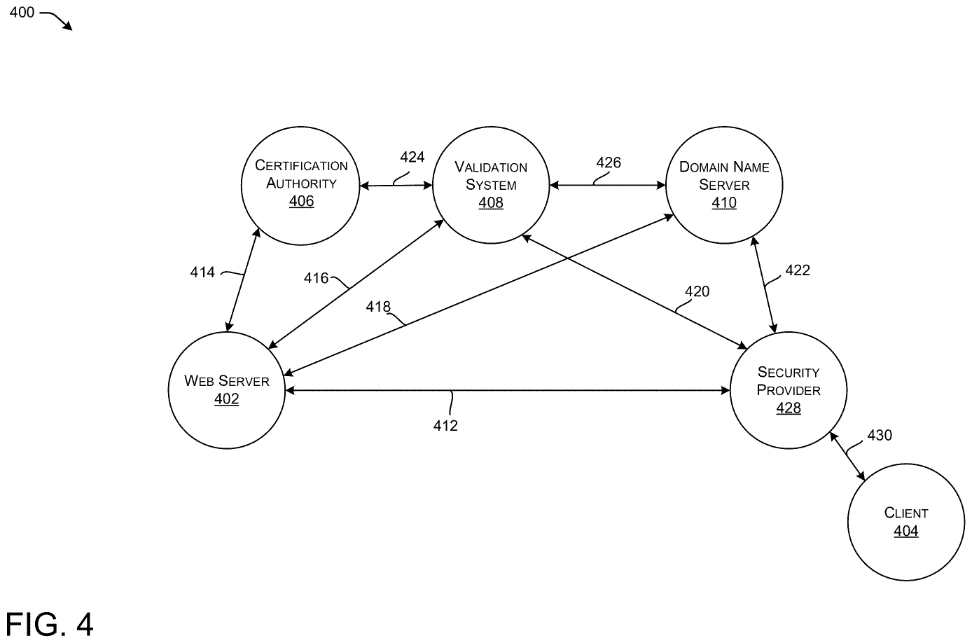

FIG. 4 provides an operational example 400 of establishing a secure communication channel between a web server 402 and a client 404 in a networked system (e.g., an enterprise system) using a CA system 406, a certificate status determination system 408, and a domain name server 410. As depicted in FIG. 4, the networked system is associated with a security provider 428.

The security provider 428 may be configured to facilitate communication of computer(s) in the networked system with external system(s). For example, the security provider 428 may be configured to facilitate the issuance, management, and/or status determination of digital certificate(s) used to establish secure communication channel(s) between a computer in the networked system (e.g., the client 404) and an external system. In some cases, the security provider 428 may intermediate a communication between a computer in the networked system (e.g., the client 404) and/or at least one of the CA system 406, the certificate status determination system 408, or the domain name server 410.

Accordingly, as depicted in FIG. 4, at operation 430, the client 404 and the security provider 428 may communicate to: (i) provide a certificate request and/or a certificate status request from the client 404 to the security provider 428, and/or (ii) provide a digital certificate and/or a certificate status response from the security provider 428 to the client 404.

In some cases, operations 414, 416, 418, 424, and 426 use techniques similar to techniques described above in relation to operations 314, 316, 318, and 326 of FIG. 3. Additionally or alternatively, in some cases, operations 412, 420, and 422 may use techniques similar to techniques described above in relation to operations 312, 320, and 322 of FIG. 3, except that communications to and/or from the client 304 are sent to and/or received from the security provider 428 instead. For example, the security provider may use domain name related information as cybersecurity threat indicator information and/or feeds.

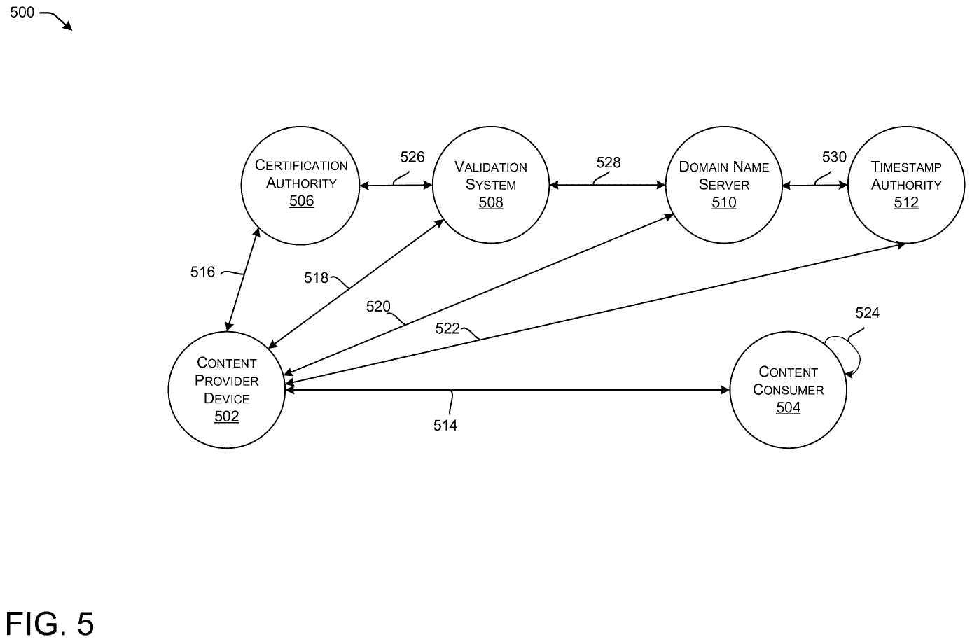

FIG. 5 provides an operational example 500 of authenticating and/or determining a status for a digital content file (e.g., a photograph, video, article, and/or the like). As depicted in FIG. 5, at operation 514, a content consumer device 504 (e.g., a client device) receives a digital certificate and/or a certificate status response from a content provider 502 (e.g., a web server system, a content provider system, a content editor system, and/or the like). These communication(s) may be performed using a networked system (e.g., enterprise system) including the security provider 428 and the client 404.

At operation 516, the content provider 502 obtains a digital certificate associated with a digital content file from a CA system 506. The content provider 502 may provide a certificate request (e.g., a CSR) to the CA system 506. The CA system 506 may then determine whether to issue the digital certificate using one or more verification procedures. The verification procedures may include: (i) verifying whether the requester is associated with a domain name registrant for the digital content file at a timestamp associated with the digital content file (e.g., as determined by the timestamp authority 512), (ii) verifying the request's digital signature using the registrant's public key, (iii) verifying whether the public key represented by the request is associated with one or more requirements (e.g., length requirement(s), cryptographic algorithm strength requirement(s), and/or the like), (iv) verifying that the requester is not on a blacklist, (v) verifying a domain name associated with the digital content file was registered at a timestamp associated with the digital content file (e.g., as determined by the timestamp authority 512), and/or the like. In some cases, the CA system 506 determines whether to issue the digital certificate based on domain name related information received from the domain name server 510 (e.g., using the techniques described above). If the CA system 506 determines to issue the digital certificate, the CA system 506 may transmit data representing the digital certificate to the content provider 502. In some cases, operation 516 is performed in implementations that use stapled digital certificates.

At operation 518, the content provider 502 obtains a certificate status response (e.g., an OCSP response indicating that the certificate is valid) from the certificate status determination system 508. The content provider 502 may first provide a certificate status request (e.g., an OCSP request) to the certificate status determination system 508. The request may represent data associated with a digital certificate. The certificate status determination system 508 may then determine whether the digital certificate is valid using one or more verification procedures. The verification procedures may include: (i) verifying whether the digital signature's serial number corresponds to a valid certificate issued by the CA system 506, (ii) verifying the certificate's expiration date to determine that the certificate is valid, (iii) verifying the certificate's digital signature using the public key associated with the CA system 506, (iv) verifying whether the certificate is marked as invalid (e.g., revoked) based on revocation data (e.g., CRL data) received from the CA system 506, (v) verifying whether the requester is associated with a domain name registrant for the digital content file at a timestamp associated with the digital content file (e.g., as determined by the timestamp authority 512), (vi) verifying a domain name associated with the digital content file was registered at a timestamp associated with the digital content file (e.g., as determined by the timestamp authority 512), and/or the like. In some cases, the certificate status determination system 508 determines a status for a digital signature based on the domain name registration received from the domain name server 510. The certificate status determination system 508 may send a certificate status response (e.g., OCSP response) indicating this determined status to the content provider 502. In some cases, operation 518 is performed in implementations that use stapled certificate status responses.

At operation 520, the content provider 502 obtains data from the domain name server 510. In some cases, operation 520 is performed in implementations that use stapled certificate status responses. In some cases, operation 520 is performed in implementations in which the digital certificate data and/or the certificate status response is provided over DNS, using a DNS response to a DNS query, and/or from the domain name server 510. For example, in some cases, the certificate status determination system 508 and the domain name server 510 are part of a system that is configured to: (i) receive a certificate status request from the content provider 502, (ii) retrieve domain name related information associated with the request from the domain name server 510, (iii) determine a certificate status response based on the retrieved domain name related information (e.g., using the techniques described above), and/or (iv) provide the certificate status response to the content provider 502. As another example, in some cases, the domain name server 510 is configured to: (i) receive a certificate status request from the content provider 502, (ii) retrieve domain name related information associated with the request, (iii) receive, from the certificate status determination system 508, data representing a determination by the certificate status determination system 508 about whether the certificate is valid, (iv) determine a certificate status response based on the retrieved domain name related information (e.g., using the techniques described above) and/or based on the data received from the certificate status determination system 508, and/or (v) provide the certificate status response to the content provider 502. As another example, in some cases, the content provider 502 is configured to: (i) provide a first certificate status request to the certificate status determination system 508 and a second certificate status request to the domain name server 510, (ii) receive a first certificate status response from the certificate status determination system 508 and/or in response to the first request, and/or (iii) receive a second certificate status response from the domain name server 510 and/or in response to the second request.

At operation 522, the content provider 502 obtains data from a timestamp authority 512. The timestamp authority 512 may be configured to assign an authoritative timestamp to a digital content file. The content provider 502 may be configured to request an authoritative timestamp associated with the digital content file, receive an authoritative timestamp in response to the request, and assign the authoritative timestamp to the digital content file. In some cases, the content provider 502 may be configured to provide the authoritative timestamp to the CA system 506 as part of a certificate request. In some cases, the CA system 506 may be configured to: (i) verify that the authoritative timestamp is generated by the timestamp authority 512 (e.g., based on verifying the authoritative timestamp's signature using the public key of the timestamp authority 512) and/or (ii) include data associated with the authoritative timestamp in the digital certificate and/or determine the digital certificate based on the authoritative timestamp. In some cases, the CA system 506 may determine whether to issue a certificate based on domain name related information associated with a time represented by the authoritative timestamp. Example techniques for determining whether to issue digital certificates based on timestamps associated with digital content files are described above.

In some cases, the content provider 502 may be configured to provide the authoritative timestamp to the certificate status determination system 508 as part of a certificate status request. In some cases, the certificate status determination system 508 may be configured to: (i) verify that the authoritative timestamp is generated by the timestamp authority 512 (e.g., based on verifying the authoritative timestamp's signature using the public key of the timestamp authority 512) and/or (ii) determine whether the certificate is valid based on domain name related information associated with a time represented by the authoritative timestamp. Example techniques for generating certificate status responses based on timestamps associated with digital content files are described above.

At operation 524, the content consumer device 504 determines whether a digital content file is authentic and/or valid based on the digital certificate and/or the certificate status response received from the content provider 502. In some cases, the content consumer device 504 may determine that the digital content file is authentic and/or valid based on: (i) verifying the digital signature associated with the received digital certificate based on a public key associated with the CA system 506, (ii) verifying the digital signature associated with the received certificate status response based on a public key associated with the certificate status determination system 508, and/or (iii) determining that the certificate status response indicates that the digital signature is valid.

At operation 526, the CA system 506 communicates with the certificate status determination system 508. Operation 526 may, for example, be performed using the techniques described above in relation to operation 314 of FIG. 3.

At operation 528, the CA system 506 communicates with the certificate status determination system 508. Operation 528 may, for example, be performed using the techniques described above in relation to operation 316 of FIG. 3.

At operation 530, the domain name server 510 may receive an authoritative timestamp from the timestamp authority 512. The domain name server 510 may verify a digital signature associated with the authoritative timestamp based on a public key associated with the timestamp authority 512. The domain name server 510 may use the authoritative timestamp to retrieve domain name related information associated with the time(s) represented by the authoritative timestamp. For example, the domain name server 510 may be configured to: (i) receive a request to determine a status for a digital certificate associated with a digital content file, (ii) identify a domain name associated with the digital content file, (iii) identify times(s) represented by the authoritative timestamp associated with the digital content file, (iv) retrieve domain name related information associated with the domain name at the time(s) represented by the authoritative timestamp, and/or (iii) determine a status for the digital certificate based on the retrieved domain name related information (e.g., using the techniques described above).

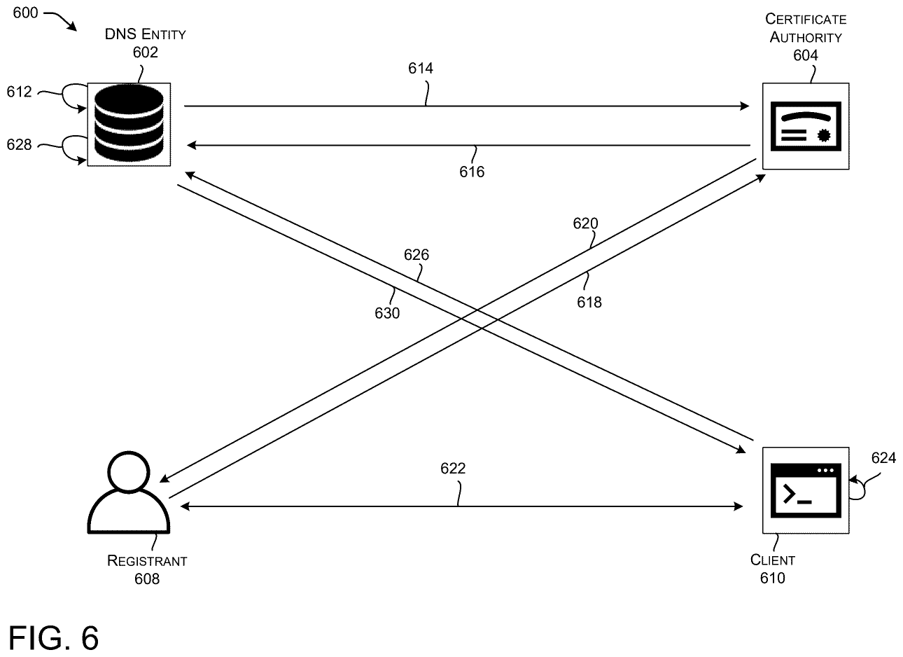

FIGS. 6-11 provide different network architectures for determining a status for digital certificates. For example, FIG. 6 provides a network architecture 600 for digital certificate status determination in which a DNS entity 602 operates as the certificate status provider. As depicted in FIG. 6, the network architecture 600 includes a DNS entity 602 (e.g., a registry system and/or a registrar system), a CA 604 (e.g., a CA system), a registrant 608 (e.g., a system used by a domain name registrant, such as a web server system), and a client 610 (e.g., a client system). As used herein, a DNS entry may include one or more a registry and/or registrar system.

As depicted in FIG. 6, at operation 612, the DNS entity 602: (i) generates a cryptographic key pair (e.g., corresponding private and public keys) and/or (ii) generates a certificate request to the CA 604. The certificate request may be a request to operate as a certificate status determination system configured to determine a status for certificate(s) issued by the CA 604. After generating this request, the DNS entity 602 may transmit the request to the CA 604 at operation 614. The CA 604 may provide the requested certificate to the DNS entity 602 at operation 616.

At operation 618, the registrant 608 provides a certificate request to the CA 604. The CA 604 may then provide a digital certificate for the associated domain name to the registrant 608 at operation 620. To determine whether to issue the certificate, the CA 604 may use the certificate issuance techniques described above.

At operation 622, the registrant 608 provides the certificate to the client 610, for example as part of a handshake process (e.g., a TLS handshake process). The client 610 may then verify that the certificate is authentic based on the public key of the CA 604. At operation 624 (e.g., which may occur after verifying the certificate is authentic based on the public key of the CA 604), the client 610 may determine that the DNS entity 602 is the status provider associated with the received certificate. At operation 626, the client 610 provides a certificate status request to the DNS entity 602. At operation 628, the DNS entity 602 determines a certificate status response (e.g., based on domain name related information associated with the registrant 608), for example using the techniques described above. The DNS entity 602 may provide the certificate status response to the client 610 at operation 630.

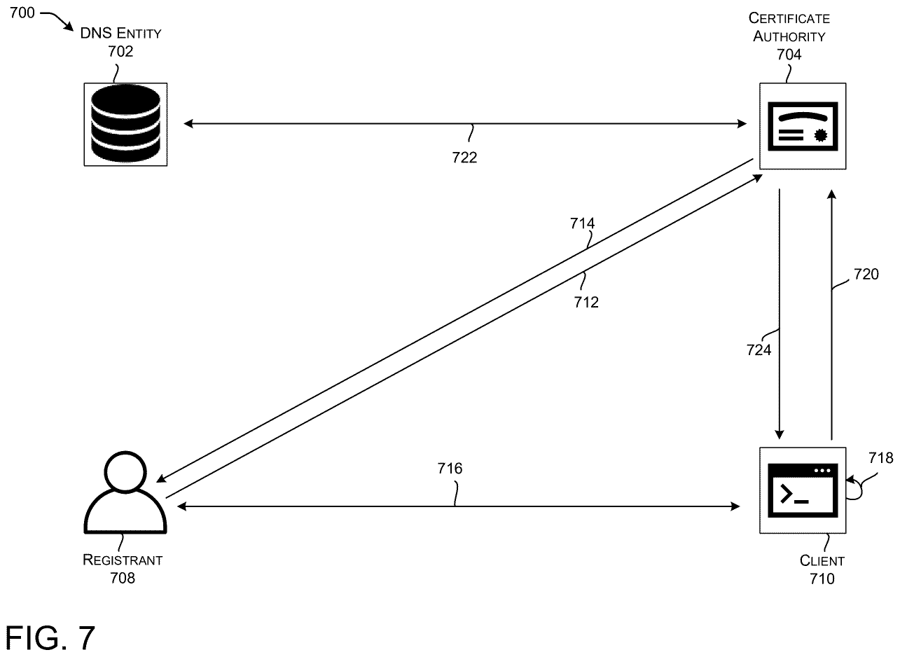

FIG. 7 provides a network architecture 700 for digital certificate status determination in which a CA 704 operates as both a digital certificate issuer and a digital certificate status provider. As depicted in FIG. 7, the network architecture 700 includes a DNS entity 702, a CA 704 (e.g., a CA system), a registrant 708 (e.g., a system used by a domain name registrant, such as a web server system), and a client 710 (e.g., a client system).

As depicted in FIG. 7, at operation 712, the registrant 708 provides a certificate request to the CA 704. The CA 704 may then provide a digital certificate for the associated domain name to the registrant 708 at operation 714.

At operation 716, the registrant 708 provides the certificate to the client 710, for example as part of a handshake process (e.g., a TLS handshake process). The client 710 may then verify that the certificate is authentic based on the public key of the CA 704. At operation 718 (e.g., which may occur after verifying that the certificate is authentic based on the public key of the CA 704), the client 710 may determine that the CA 704 is the status provider associated with the received certificate. At operation 720, the client 710 may provide a certificate status request to the CA 704.

At operation 722, the CA 704 may provide a request for domain name related information associated with the certificate to the DNS entity 702. Operation 722 may be performed periodically (e.g., as part of periodic retrieval of a set of domain name related information), in response to receiving the certificate status request from the client 710, and/or the like.

At operation 724, the CA 704 may determine a certificate status response (e.g., based on domain name related information associated with the registrant 708), for example using the techniques described above. The CA 704 may provide the certificate status response to the client 710 at operation 724.

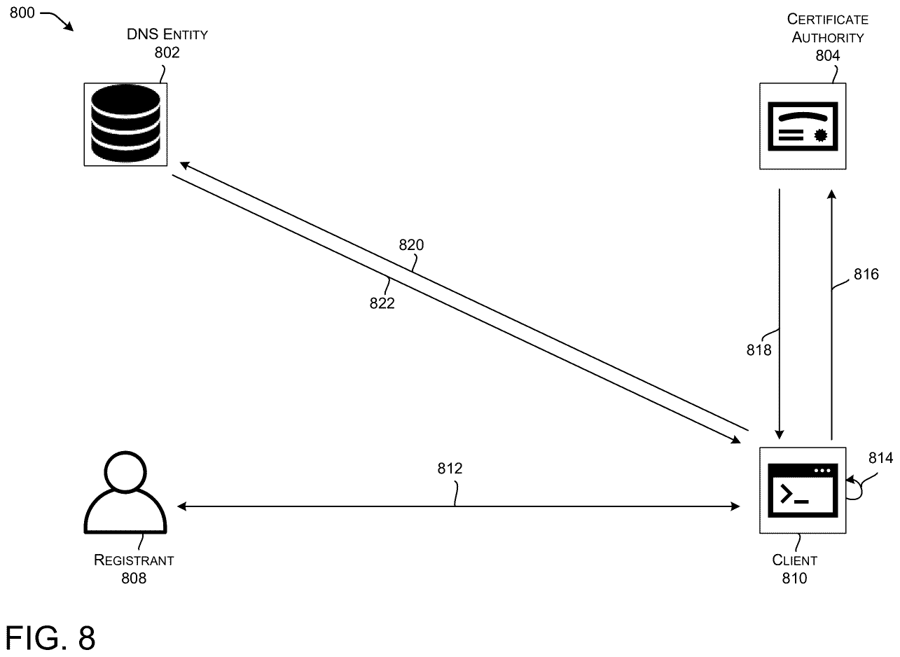

FIG. 8 provides a network architecture 800 for digital certificate status determination in which both the DNS entity 802 and the CA 804 operate as certificate status providers. As depicted in FIG. 8, the network architecture 800 includes a DNS entity 802, a CA 804 (e.g., a CA system), a registrant 808 (e.g., a system used by a domain name registrant, such as a web server system), and a client 810 (e.g., a client system).

As depicted in FIG. 8, at operation 812, the client 810 receives a digital certificate from the registrant 808. The client 810 may determine that the CA 804 and the DNS entity 802 are the status providers for the received certificate at operation 814. The client 810 may then: (i) provide a first certificate status request for determining the status of the digital certificate to the CA 804 at operation 816 and receive a first certificate status response from the CA 804 at operation 818, and/or (ii) provide a second certificate status request for determining the status of the digital certificate to the DNS entity 802 at operation 820 and receive a second certificate status response from the DNS entity 802 at operation 822. In some cases, the first certificate status response is not determined based on the domain name related information, and/or the second certificate status response is determined based on domain name related information (e.g., using the techniques described above).

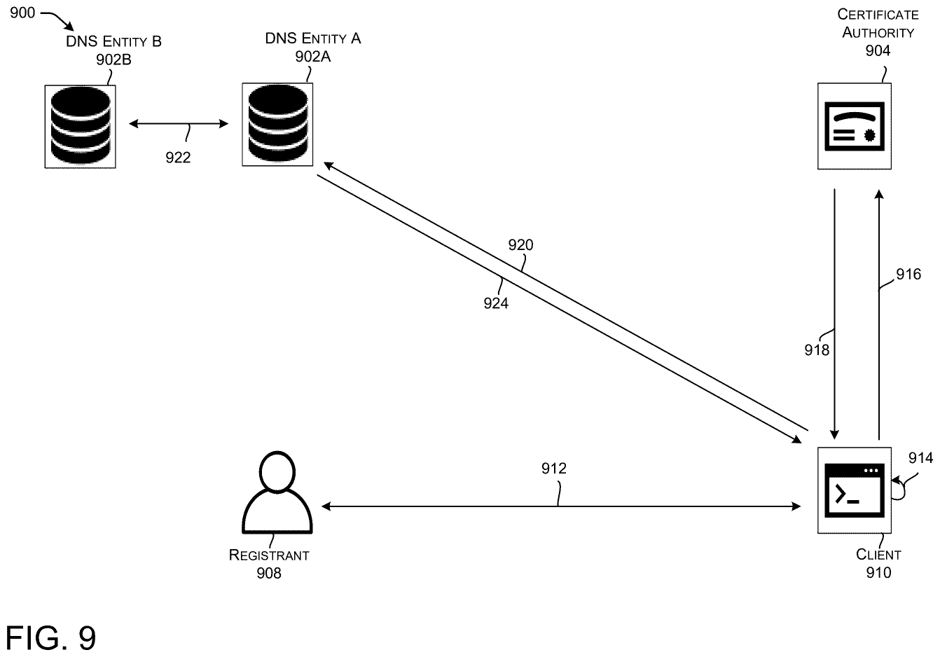

FIG. 9 provides a network architecture 900 for digital certificate status determination in which a DNS entity A 902A (e.g., a registrar) operates as the certificate status provider for a domain name that is not associated with the DNS entity's top-level domain (TLD). As depicted in FIG. 9, the network architecture 900 includes a DNS entity A 902A, a DNS entity B 902B, a CA 904 (e.g., a CA system), a registrant 908 (e.g., a system used by a domain name registrant, such as a web server system), and a client 910 (e.g., a client system). In some cases, each DNS entity is associated with one or more TLDs. For example, in FIG. 8, DNS entity A 902A may be associated with “tld1” domain names, while DNS entity B 902B may be associated with “.tld2” domain names.

As depicted in FIG. 9, at operation 912, the client 910 receives a digital certificate associated with a domain name from the registrant 908. At operation 914, the client 910 determines that the CA 904 and the DNS entity A 902A are status providers associated with the domain name. The client 910 may then send a first certificate status request to the CA 904 at operation 916 and/or send a second certificate status request to the DNS entity A 902A at operation 920. The CA 904 may determine a first certificate status response and transmit the first certificate status response to the client 910 at operation 918.

The DNS entity A 902A may determine that the domain name is associated with a TLD that is different from the TLD associated with the DNS entity A 902A. For example, the DNS entity A 902A may be associated with “.tld1” but determine that the domain name is associated with “.tld2”. Accordingly, at operation 922, the DNS entity A 902A may retrieve the domain name related information associated with the domain name from DNS entity B 902B, which is the DNS entity associated with the domain name's TLD. DNS entity A 902A may then determine a second certificate status response based on the retrieved domain name related information (e.g., using the techniques described above) and send the second certificate status response to the client 910 at operation 924.

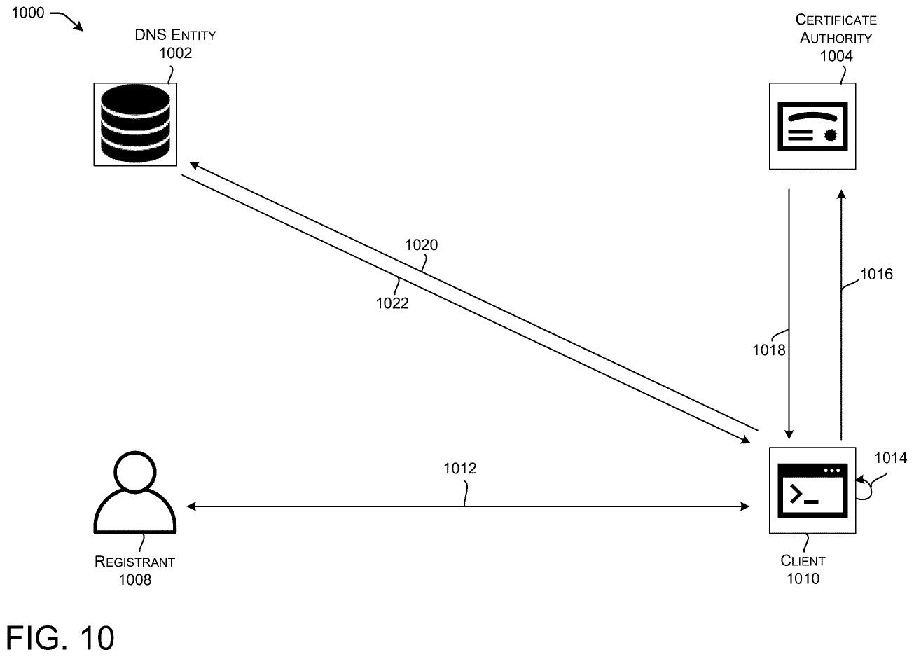

FIG. 10 provides a network architecture 1000 for digital certificate status determination for a subdomain. As depicted in FIG. 10, the network architecture 1000 includes a DNS entity 1002, a CA 1004 (e.g., a CA system), a registrant 1008 (e.g., a system used by a domain name registrant, such as a web server system), and a client 1010 (e.g., a client system).

As depicted in FIG. 10, at operation 1012, the registrant 1008 receives a request to establish a secure connection with a subdomain from the client 1010, retrieves the digital certificate associated with the subdomain, and provides the digital certificate to the client 1010. At operation 1014, the client 1010 determines that the digital certificate is associated with the subdomain and identifies the DNS entity 1002 and the CA 1004 as the certificate status providers for that digital certificate and/or for the subdomain.

The client 1010 may then: (i) provide a first certificate status request for determining the status of the digital certificate to the CA 1004 at operation 1016 and receive a first certificate status response from the CA 1004 at operation 1018, and/or (ii) provide a second certificate status request for determining the status of the digital certificate to the DNS entity 1002 at operation 1020 and receive a second certificate status response from the DNS entity 1002 at operation 1022. In some cases, the first certificate status response is not determined based on domain name related information, and/or the second certificate status response is determined based on domain name related information (e.g., using the techniques described above).

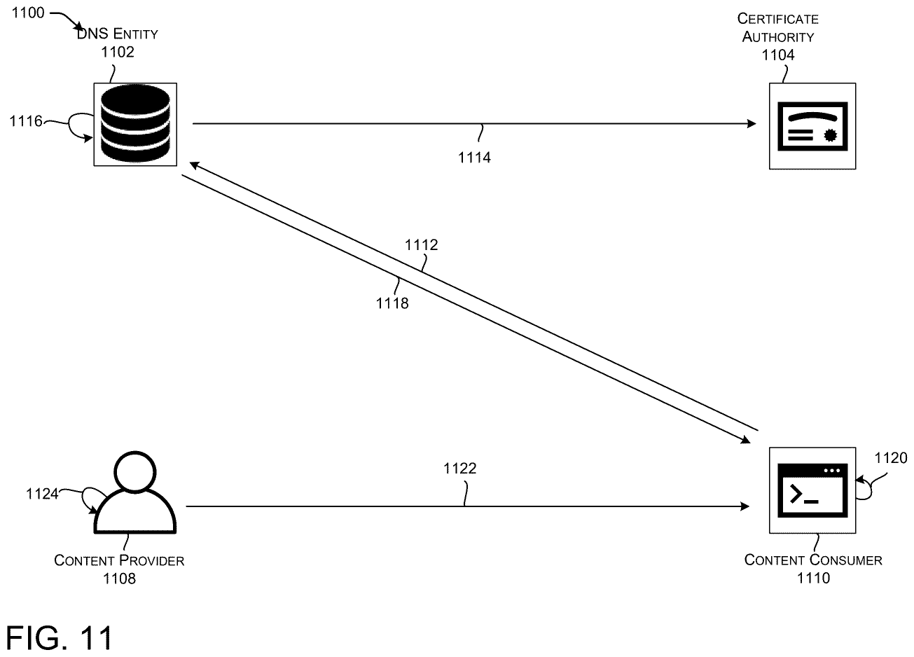

FIG. 11 provides a network architecture 1100 for digital certificate status determination for a digital certificate associated with a digital content file. As depicted in FIG. 11, the network architecture 1100 includes a DNS entity 1102, a CA 1104 (e.g., a CA system), a content consumer 1108 (e.g., a client system), and a content provider 1110 (e.g., a system used by a domain name registrant, a content provider, and/or a content editor, such as a web server system).

As depicted in FIG. 11, at operation 1112, the content provider 1110 provides a request for a digital certificate status determination associated with a digital request associated with a digital content file to the DNS entity 1102. At operation 1114, the DNS entity 1102 communicates with the CA 1104 to determine whether the digital certificate is invalid (e.g., has been revoked). At operation 1116, the DNS entity 1102 determines a certificate status response based on the domain name related information for a domain name associated with the digital content file and/or based on the revocation query results received from the CA 1104. At operation 1118, the DNS entity 1102 provides the certificate status response to the content provider 1110.

At operation 1120, the content provider 1110 includes the certificate status response in the digital content file and/or in additional evidence data associated with the digital content file. For example, in some cases, the content provider 1110 embeds the certificate status response and/or data representing the certificate status response into the digital content file and/or into the additional evidence data.

At operation 1122, the content provider 1110 provides the certificate status response (e.g., as part of the digital content file and/or additional evidence data associated with the digital content file) to the content consumer 1108. At operation 1124, the content consumer 1108 verifies that the digital content file is authentic based on the certificate status response. For example, the content consumer 1108 may verify that the that the digital content file is authentic based on determining that: (i) a digital signature associated with the certificate status response has been signed by the public key of the DNS entity 1102, and/or (ii) the certificate status response indicates that the digital certificate associated with the digital content file is valid.

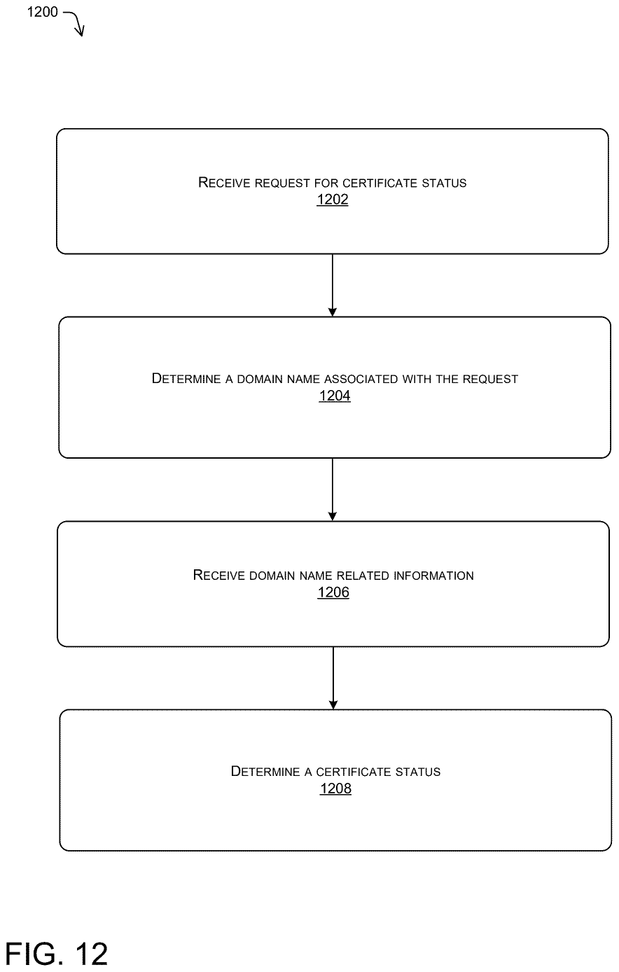

FIG. 12 is a flowchart diagram of an example process 1200 for determining a certificate status response based on domain name related information. The process 1200 may be performed by a certificate status determination system, such as the certificate status determination system 308 depicted in FIG. 3, the certificate status determination system 408 depicted in FIG. 4, and/or the certificate status determination system 508 depicted in FIG. 5.

The process 1200 begins at operation 1202, where the certificate status determination system receives a request to determine a status for a digital certificate. The request may include data associated with the digital certificate whose status is being determined, such as the digital certificate's serial number, CA issuer, validity period, and/or digital signature. Examples of certificate status requests are described above.

At operation 1204, the certificate status determination system determines a domain name associated with the certificate status request. In some cases, the certificate status determination system extracts a domain name from a certificate status response. For example, the certificate status determination system may extract the domain name from a field in the certificate status request that identifies a domain name. In some cases, the certificate status determination system extracts a digital certificate from the certificate status request and then extracts the domain name from a field of the digital certificate. For example, the certificate status determination system may determine the domain name(s) associated with the certificate based on the subject field and/or the subject alternative name extension of the digital certificate.

At operation 1206, the certificate status determination system receives domain name related information associated with the domain name determined at operation 1204. For example, in some cases, the certificate status determination system may retrieve the domain name related information associated with the determined domain name from a domain name registration system (e.g., a domain name registry system). The domain name related information may include information such as the domain name's registrant, registration status, registration period, and/or status codes. In some cases, the certificate status determination system periodically retrieves domain name related information associated with a set of domain names from a domain name server. In some cases, the certificate status determination system may include the domain name registration system (e.g., the certificate status determination system and the domain name registration system are part of the same system). Example techniques for determining domain name related information using a certificate status determination system are described above.

At operation 1208, the certificate status determination system determines a status response based on the domain name related information received at operation 1206. Example techniques for determining a certificate status response based on domain name related information associated with a corresponding domain name are described above.

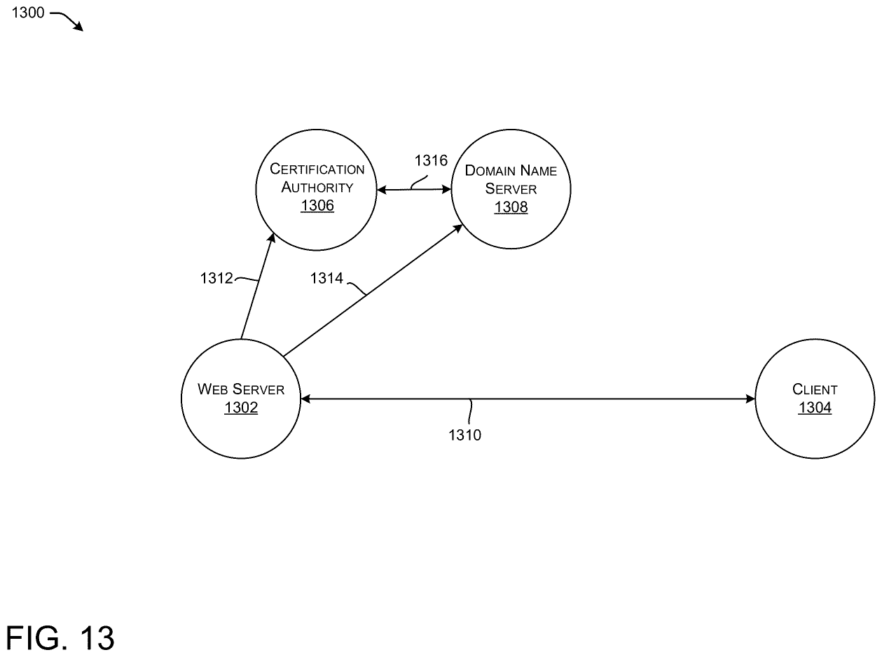

FIG. 13 provides an operational example 1300 of determining a secure communication channel between a web server 1302 and a client 1304 using a time-limited digital certificate. As depicted in FIG. 13, at operation 1310, the client 1304 obtains a time-limited digital certificate from the web server 1302. Operation 1310 may, for example, be performed in implementations that establish a secure communication using a stapled digital certificate.

At operation 1312, the web server 1302 obtains a time-limited digital certificate from a CA system 1306. Operation 1312 may, for example, be performed in implementations that establish a secure communication using a stapled digital certificate. In some cases, the CA system 1306 issues the time-limited digital certificate based on domain name related information (e.g., received from the domain name server system 1308). Example techniques for determining a time-limited digital certificate (e.g., based on domain name related information) are described above.

At operation 1314, the web server 1302 obtains data from the domain name server system 1308. In some cases, operation 1314 is performed in implementations that use stapled digital certificates. In some cases, operation 1314 is performed in implementations in which the digital certificate data are provided over DNS, using a DNS response to a DNS query, and/or from the domain name server 310. For example, in some cases, the CA system 1306 and the domain name server system 1308 are part of a system that is configured to: (i) receive a certificate request from the web server 1302, (ii) retrieve domain name related information associated with the request from the domain name server system 1308, (iii) determine a decision to issue the digital certificate based on the retrieved domain name related information (e.g., using the techniques described above), and/or (iv) issue a digital certificate and provide the issued digital certificate to the web server 1302. As another example, in some cases, the domain name server system 1308 is configured to: (i) receive a certificate request from the web server 1302, (ii) retrieve domain name related information associated with the request, (iii) receive, from the CA system 1306, data representing a determination by the CA system 1306 to authorize issuance of the certificate, (iv) determine to issue a digital certificate based on the retrieved domain name related information (e.g., using the techniques described above) and/or based on the data received from the CA system 1306, and/or (iv) issue a digital certificate and provide the issued certificate to the web server 1302.

At operation 1316, the CA system 1306 communicates with the domain name server system 1308 to obtain domain name related information. As described above, in some cases, the CA system 1306 issues the time-limited digital certificate based on domain name related information (e.g., received from the domain name server system 1308). Example techniques for issuing a time-limited digital certificate (e.g., based on domain name related information) are described above.

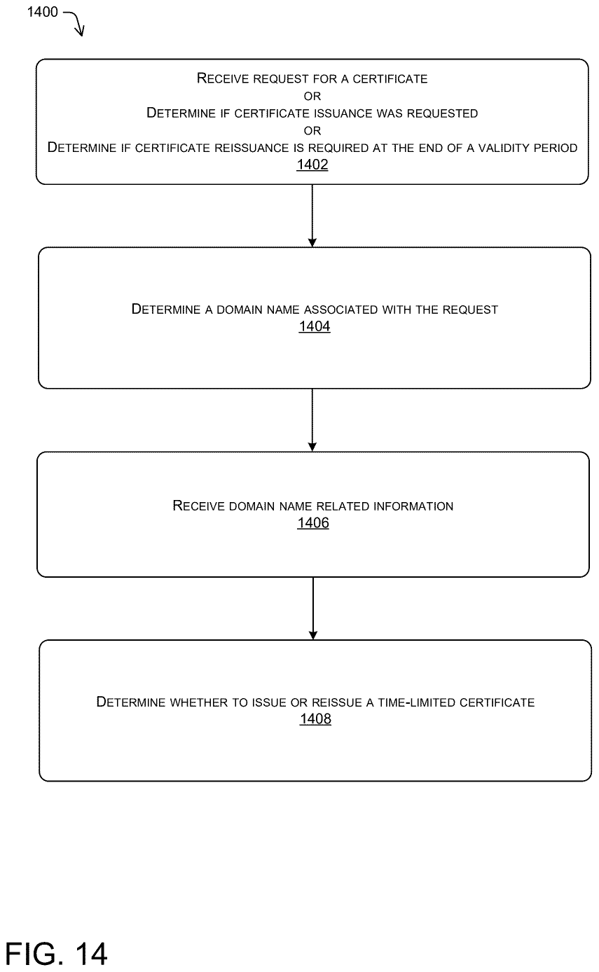

FIG. 14 is a flowchart diagram of an example process 1400 for issuing or reissuing a time-limited digital certificate. The process 1400 may be performed by a CA system, such as the CA system 306 depicted in FIG. 3, the CA system 406 depicted in FIG. 4, and/or the CA system 506 depicted in FIG. 5.

The process 1400 begins at operation 1402, where the CA system receives a request for a digital certificate, determines if re-issuance of a certificate has been requested, or determines is re-issuance of a certificate is required due to expiration of the certificate's validity period. The request may be received from a client device and/or a web server system. The certificate request may, for example, be a CSR. Examples of digital certificate requests are described above. The determination of whether re-issuance of a certificate has been requested or whether re-issuance of a certificate is required due to expiration of the certificate's validity period may be based on a determination made at the time the certificate was issued, a policy based on the certificate authority, a policy based on the certificate holder, and/or a determination made at the time the certificate expires.

At operation 1404, the CA system obtains domain name related information. The CA system may receive domain name related information using the techniques described above, for example as described above in relation to operation 1204 depicted in FIG. 12.

At operation 1406, the CA system determines the domain name associated with the certificate request. In some cases, the CA system extracts the domain name from one or more fields of the CFR. In some cases, the CA system may extract the domain name from one or more fields (e.g., a fully-qualified domain name (FQDN) field, a subject alternative name extension, and/or the like) of a CSR associated with the certificate request.

At operation 1408, the CA system issues or reissues the time-limited certificate based on the domain name related information associated with the domain name. For example, the CA system may generate a digital certificate (e.g., an X.509 digital certificate) that includes the client device's public key, the domain name requested in the certificate request, and/or a validity period associated with the digital certificate (e.g., as determined using the techniques described above). Example techniques for issuing time-limited certificates (e.g., for determining validity periods for such time-limited certificates) are described above.

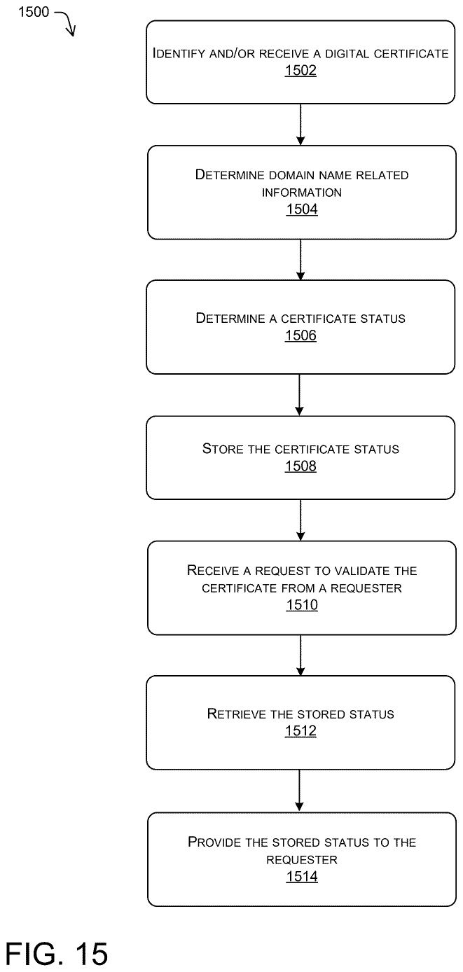

FIG. 15 is a flowchart diagram of an example process 1500 for performing certificate status determination operations based on domain name related information. The process 1500 may, for example, be performed by a certificate status determination system. As depicted in FIG. 15, at operation 1502, an example system receives and/or identifies a digital certificate.

At operation 1504, the system determines domain name related information associated with the digital certificate. The domain name related information may be related to a domain name that is associated with the certificate. Examples of domain name related information are described above.

At operation 1506, the system determines a certificate status associated with the digital certificate based on the domain name related information. The certificate status may indicate whether the digital certificate is valid. Example techniques for determining a certificate status based on domain name related information are described above.

At operation 1508, the system stores the determined certificate status. For example, the system may store the certificate in a database and/or other data store associated with the system, for example as part of DNS record(s) associated with the domain name.

At operation 1510, the system receives a request to receive a status associated with the digital certificate from a requestor. The requester may be a client device, a DNS entity, and/or CA system. The request may include data associated with the digital certificate, such as the digital certificate's serial number, CA issuer, validity period, and/or digital signature. Examples of certificate status requests are described above.

At operation 1512, the system retrieves the stored certificate status associated with the digital certificate. The system may retrieve the stored certificate status from a database and/or other data store where the certificate status was stored at operation 1508.

At operation 1514, the system provides the retrieved certificate status to the requester. For example, the system may determine the status as part of a certificate status response provided in response to the requester's certificate status request. Example of certificate status responses are described above.

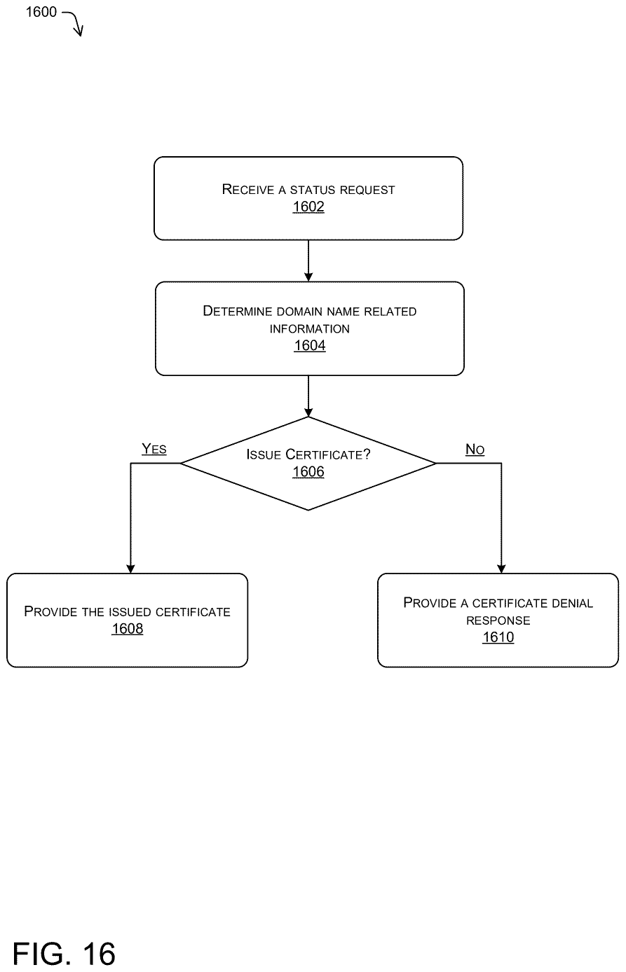

FIG. 16 is a flowchart diagram of an example process 1600 for digital certificate management based on domain name related information. The process 1600 may, for example, be performed by a certificate authority (CA) system. As depicted in FIG. 16, at operation 1602, a system receives a request for issuing a digital certificate associated with a domain name. The request may include data associated with the domain name and/or digital certificate to be issued, such as the domain name, the certificate's public key, the certificate's validity period, and/or the like.

At operation 1604, the system determines domain name related information associated with the digital certificate. The domain name related information may be related to the domain name that is associated with the certificate. Examples of domain name related information that may be used to determine whether to issue or reissue a digital certificate (e.g., a time-limited digital certificate) are described above.

At operation 1606, the system determines whether to issue the digital certificate based on the domain name related information. Example techniques for determining whether to issue a digital certificate based on domain name related information are described above.

If the system determines to issue the digital certificate (operation 1606 - Yes), the system provides the issued certificate to the requester at operation 1608. However, if the system determines not to issue the digital certificate at operation 1606 (operation 1606 - No), the system provides a certificate denial response to the requester at operation 1610.

### Example Computing Devices

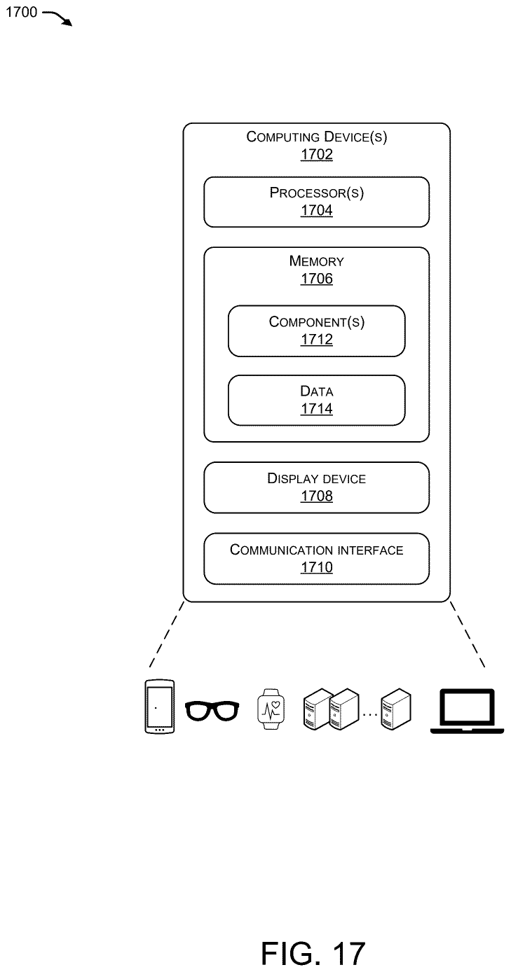

FIG. 17 depicts an example computing device 1700 for implementing the techniques described herein. For example, the computing device(s) 1702 comprises processor(s) 1704, memory 1706, a display device 1708, and a communication interface 1710. As shown in FIG. 17, the memory 1706 comprises one or more components 1712 and data 1714. In some examples, the computing device(s) 1702 can be configured to perform the functionality of a CA system and/or a certificate status determination system.

The processor(s) 1704 can be any suitable processor capable of executing instructions to process data and perform operations as described herein. By way of example and not limitation, the processor(s) 1704 can comprise one or more Central Processing Units (CPUs), Graphics Processing Units (GPUs), Tensor Processing Units (TPUs), or any other device or portion of a device that processes electronic data to transform that electronic data into other electronic data that can be stored in registers and/or memory. In some examples, the processor(s) can represent a Redundant Array of Inexpensive Disk drives (RAID) configuration. In some examples, integrated circuits (e.g., ASICs, etc.), gate arrays (e.g., FPGAs, etc.), and other hardware devices configured to implement encoded instructions can also be considered processors. In various examples, the processor(s) 1704 can be communicatively coupled to the memory 1706 and be configured to execute instructions stored on or otherwise associated with the memory 1706 to implement the techniques described herein.

In various examples, the memory 1706 can include system memory, which may be volatile (such as RAM), non-volatile (such as ROM, flash memory, etc.) or some combination of the two. The memory 1706 can also or instead include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computing device(s) 1702.

The memory 1706 can store one or more components 1712 and/or data 1714 represent an operating system, a software application, instruction, program, and/or data to implement the methods described herein and the functions attributed to the various systems. The architectures, systems, and individual elements described herein can include many other logical, programmatic, and physical components, of which those shown in the accompanying figures are merely examples that are related to the discussion herein. In some examples, the memory can represent an Error-Correcting Code (ECC) memory hardware device, or other storage device.

A display device 1708 can represent an output device capable of presenting information for display. For example, the display device 1708 can represent a liquid crystal display, a touch-sensitive display, a peripheral display, or other device for presenting data associated with a domain name.

The communication interface 1710 can represent functionality to communicatively couple the computing device(s) 1702 to a network to enable an exchange of data with another commuting device. In various examples, the communication interface 1710 can include a physical network interface, such as a network adapter, communication device, transceiver, modems interfaces, antenna, or the like. The communication interface 1710 can additionally or alternatively include logical interfaces for connecting the computing device(s) 1702 to another computing device or one or more external networks (e.g., the Internet). For example, the communication interface 1710 can enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.), satellite communication, dedicated short-range communications (DSRC), or any suitable wired or wireless communications protocol that enables the respective computing device to interface with the other computing device(s).

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes examples having specific structural features and/or methodological acts, it is to be understood that the claims are not necessarily limited to the specific features or acts described. Rather, the specific features and acts are merely illustrative of some examples that fall within the scope of the claims of the application.

The methods described herein represent sequences of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes. In some examples, one or more operations of the method may be omitted entirely. Moreover, the methods described herein can be combined in whole or in part with each other or with other methods.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

Use of language, such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

### Example Clauses

The following paragraphs describe various examples. Any of the examples in this section may be used with any other of the examples in this section and/or any of the other examples or embodiments described herein.

A: A system comprising: one or more processors; and one or more non-transitory computer-readable media storing computer-executable instructions that, when executed, cause the system to perform operations comprising: determining domain name related information associated with a domain name; determining, based on the domain name related information, a status associated with a digital certificate, the digital certificate being associated with the domain name; receiving, from a first device, a request for the status; and providing the status to the first device.

B: The system of paragraph A, wherein: the system is an Online Certificate Status Protocol (OCSP) responder, and the first device is a client device that has sent an OCSP request to the system.

C: The system of paragraph B, wherein: the request is a first OCSP request; the first device is configured to send the first OCSP request to the system and a second OCSP request to a second OCSP responder, and the second OCSP responder is configured to receive the domain name related information from the system.

D: The system of any of paragraphs A-C, wherein the system is a registry associated with a first top-level domain, and wherein determining the domain name related information comprises: determining that the domain name is associated with a second top-level domain, the second top-level domain being associated with a second registry; and receiving the domain name related information from the second registry.

E: The system of any of paragraphs A-D, wherein determining the status comprises: determining a registrant associated with the domain name; determining a certificate holder associated with the registrant; and determining that the digital certificate is invalid based on determining that the registrant and the certificate holder fail to match.

F: The system of any of paragraphs A-E, wherein determining the status comprises: determining data representing that the domain name is at least one: currently unregistered, or unregistered at a time associated with the digital certificate; and determining that the digital certificate is invalid based on the data.

G: The system of any of paragraphs A-F, wherein the digital certificate is associated with a subdomain name of the domain name, and wherein determining the status comprises: determining, based on the domain name related information, an event associated with the domain name; and determining the status based on the event.

H: The system of any of paragraphs A-G, wherein the request is received via a domain name system (DNS) query, and wherein the status is provided via a DNS response.

I: The system of any of paragraphs A-H, wherein the request is received via a Hyper-Text Transfer Protocol Secure (HTTPS) request, and wherein the status is provided via an HTTPS response.

J: The system of any of paragraphs A-I, the operations further comprising: generating a timestamp associated with determining the status; and providing the timestamp to the first device along with the status.

K: The system of any of paragraphs A-J, wherein the digital certificate is associated with a digital content item, and wherein determining the status comprises: determining a timestamp associated with the digital content item; determining that the domain name was registered at a first time represented by the timestamp; determining, based on the domain name related information, data representing a registration status associated with the domain name at the first time; and determining the status based on the data.

L: The system of any of paragraphs A-K, wherein the domain name related information comprises a domain name system (DNS) record representing a valid digital certificate associated with the domain name.

M: The system of any of paragraphs A-L, wherein retrieving the domain name related information comprises: sending a request to a Registry Data Directory Service (RDDS) server associated with the domain name; and receiving the domain name related information from the RDDS server in response to the request.

N: The system of any of paragraphs A-M, the operations further comprising: receiving, by a web server associated with the domain name, the status from the system; generating, by the web server, a stapled response including the status; and providing, by the web server, the stapled response in response to a request for a web resource.

O: The system of any of paragraphs A-N, wherein determining the status comprises: determining, based on the domain name related information, data representing that an accreditation status associated with the domain name is invalid; and determining the status based on the data.

P: A system comprising: one or more processors; and one or more non-transitory computer-readable media storing computer-executable instructions that, when executed, cause the system to perform operations comprising: determining domain name related information associated with a domain name; receiving a request for the domain name related information from a first device; and providing the domain name related information to the first device, wherein the first device is configured to: determine, based on the domain name related information, a status associated with a digital certificate, the digital certificate being associated with the domain name, and provide the status to a second device.

Q: The system of paragraph P, wherein: the system is a registry, the first device is an Online Certificate Status Protocol (OCSP) responder, and the second device is a client device that has sent an OCSP request to the first device.

R: A system comprising: one or more processors; and one or more non-transitory computer-readable media storing computer-executable instructions that, when executed, cause the system to perform operations comprising: receiving, from a web server associated with a domain name, a request for a digital certificate associated with the domain name; determining domain name related information associated with the domain name; determining, based on receiving the request and the domain name related information, first data representing a decision to issue the digital certificate; determining a time limit associated with the digital certificate based on a first time associated with determining the first data; determining the digital certificate based on the time limit; and providing the digital certificate to the web server.

S: The system of paragraph R, the operations further comprising: receiving, at a second time, a second request for a second digital certificate associated with the domain name; based on receiving the second request, determining second domain name related information associated with the domain name; and determining, based on the second domain name related information, second data representing a second decision to refrain from issuing the second digital certificate.

T: The system of paragraph R or S, wherein determining the time limit comprises: determining, based on the domain name related information, an accreditation status associated with the domain name; determining an expiration period based on the accreditation status; and determining the time limit based on the first time and the expiration period.

U: The system of any of paragraphs R-T, the operations further comprising storing the digital certificate as a domain name system (DNS) record associated with the domain name.

V: The system of any of paragraphs R-U, wherein the web server is configured to: provide the digital certificate to a client device requesting a secure communication channel; receive, from the client device, a first message encrypted using a public key associated with the digital certificate; and send, to the client device, a second message encrypted using a symmetric key established based on the secure communication channel.

W: One or more non-transitory computer-readable media storing processor-executable instructions that, when executed by one or more processors, cause the one or more processors to perform any of the operations or functions disclosed herein.

X: A method comprising any of the operations or functions disclosed herein.

While the example clauses described above are described with respect to one particular implementation, it should be understood that, in the context of this document, the content of the example clauses can also be implemented via a method, device, system, computer-readable medium, and/or another implementation. Additionally, any of examples A-X can be implemented alone or in combination with any other one or more of the examples A-X.

### Conclusion

While one or more examples of the techniques described herein have been described, various alterations, additions, permutations, and equivalents thereof are included within the scope of the techniques described herein.

What is claimed is:

1. A system comprising:
one or more processors; and
one or more non-transitory computer-readable media storing computer-executable instructions that, when executed, cause the system to perform operations comprising:
determining domain name related information associated with a domain name;
determining, based on the domain name related information, a status associated with a digital certificate, the digital certificate being associated with the domain name;
receiving, from a first device, a request for the status; and
providing the status to the first device.

2. The system of claim 1, wherein:
the system is an Online Certificate Status Protocol (OCSP) responder, and
the first device is a client device that has sent an OCSP request to the system.

3. The system of claim 2, wherein:
the request is a first OCSP request;
the first device is configured to send the first OCSP request to the system and a second OCSP request to a second OCSP responder, and
the second OCSP responder is configured to receive the domain name related information from the system.

4. The system of claim 1, wherein the system is a registry associated with a first top-level domain, and wherein determining the domain name related information comprises:
determining that the domain name is associated with a second top-level domain, the second top-level domain being associated with a second registry; and
receiving the domain name related information from the second registry.

5. The system of claim 1, wherein determining the status comprises:
determining a registrant associated with the domain name;
determining a certificate holder associated with the registrant; and
determining that the digital certificate is invalid based on determining that the registrant and the certificate holder fail to match.

6. The system of claim 1, wherein determining the status comprises:
determining data representing that the domain name is at least one:
currently unregistered, or
unregistered at a time associated with the digital certificate; and
determining that the digital certificate is invalid based on the data.

7. The system of claim 1, wherein the digital certificate is associated with a subdomain name of the domain name, and wherein determining the status comprises:
determining, based on the domain name related information, an event associated with the domain name; and
determining the status based on the event.

8. The system of claim 1, wherein the request is received via a domain name system (DNS) query, and wherein the status is provided via a DNS response.

9. The system of claim 1, wherein the request is received via a Hyper-Text Transfer Protocol Secure (HTTPS) request, and wherein the status is provided via an HTTPS response.

10. The system of claim 1, the operations further comprising:
generating a timestamp associated with determining the status; and
providing the timestamp to the first device along with the status.

11. The system of claim 1, wherein the digital certificate is associated with a digital content item, and wherein determining the status comprises:
determining a timestamp associated with the digital content item;
determining that the domain name was registered at a first time represented by the timestamp;
determining, based on the domain name related information, data representing a registration status associated with the domain name at the first time; and
determining the status based on the data.

12. The system of claim 1, wherein the domain name related information comprises a domain name system (DNS) record representing a valid digital certificate associated with the domain name.

13. The system of claim 1, wherein retrieving the domain name related information comprises:
sending a request to a Registry Data Directory Service (RDDS) server associated with the domain name; and
receiving the domain name related information from the RDDS server in response to the request.

14. The system of claim 1, the operations further comprising:
receiving, by a web server associated with the domain name, the status from the system;
generating, by the web server, a stapled response including the status; and
providing, by the web server, the stapled response in response to a request for a web resource.

15. The system of claim 1, wherein determining the status comprises:
determining, based on the domain name related information, data representing that an accreditation status associated with the domain name is invalid; and
determining the status based on the data.

16. A system comprising:
one or more processors; and
one or more non-transitory computer-readable media storing computer-executable instructions that, when executed, cause the system to perform operations comprising:
determining domain name related information associated with a domain name;
receiving a request for the domain name related information from a first device; and
providing the domain name related information to the first device, wherein the first device is configured to:
determine, based on the domain name related information, a status associated with a digital certificate, the digital certificate being associated with the domain name, and
provide the status to a second device.

17. The system of claim 16, wherein:
the system is a registry,
the first device is an Online Certificate Status Protocol (OCSP) responder, and
the second device is a client device that has sent an OCSP request to the first device.

18. A system comprising:
one or more processors; and
one or more non-transitory computer-readable media storing computer-executable instructions that, when executed, cause the system to perform operations comprising:
receiving, from a web server associated with a domain name, a request for a digital certificate associated with the domain name;
determining domain name related information associated with the domain name;
determining, based on receiving the request and the domain name related information, first data representing a decision to issue the digital certificate;
determining a time limit associated with the digital certificate based on a first time associated with determining the first data;
determining the digital certificate based on the time limit; and
providing the digital certificate to the web server.

19. The system of claim 18, the operations further comprising:
receiving, at a second time, a second request for a second digital certificate associated with the domain name;
based on receiving the second request, determining second domain name related information associated with the domain name; and
determining, based on the second domain name related information, second data representing a second decision to refrain from issuing the second digital certificate.

20. The system of claim 18, wherein determining the time limit comprises:
determining, based on the domain name related information, an accreditation status associated with the domain name;
determining an expiration period based on the accreditation status; and
determining the time limit based on the first time and the expiration period.

21. The system of claim 18, the operations further comprising storing the digital certificate as a domain name system (DNS) record associated with the domain name.

22. The system of claim 18, wherein the web server is configured to:
provide the digital certificate to a client device requesting a secure communication channel;
receive, from the client device, a first message encrypted using a public key associated with the digital certificate; and
send, to the client device, a second message encrypted using a symmetric key established based on the secure communication channel.
